(19) United States
(12) Patent Application Publication
(10) Pub. No.: US 2026/0134883 A1
(43) Pub. Date: May 14, 2026

(54) MAGNETIC TAPE, MAGNETIC TAPE CARTRIDGE, AND MAGNETIC TAPE APPARATUS

(71) Applicant: FUJIFILM Corporation, Tokyo (JP)

(72) Inventors: Ryosuke YUMIYAMA, Minamiashigara-shi (JP); Norihito Kasada, Minamiashigara-shi (JP)

(73) Assignee: FUJIFILM Corporation, Tokyo (JP)

(21) Appl. No.: 19/331,496

(22) Filed: Sep. 17, 2025

(30) Foreign Application Priority Data
Sep. 20, 2024 (JP) 2024-163809

(51) Int. Cl. G11B 5/706; G11B 5/008; G11B 5/714; G11B 5/735

(52) U.S. Cl. CPC G11B 5/70678; G11B 5/00817; G11B 5/714; G11B 5/7356

(57) ABSTRACT

The magnetic tape includes a non-magnetic support, and a magnetic layer containing a ferromagnetic powder. A rate of change in an area ratio of a protrusion having a height of 5 nm or more and 10 nm or less, which is obtained by measuring a measurement region of 5 μm×5 μm on a surface of the magnetic layer before and after 1000 reciprocating slides with respect to an LTO 8 head at a head tilt angle of 15° in an environment of a temperature of 35° C. and a relative humidity of 80%, with an atomic force microscope, is 10.0% or less.

### CROSS-REFERENCE TO RELATED APPLICATIONS

This application claims priority under 35 U.S.C 119 to Japanese Patent Application No. 2024-163809 filed on Sep. 20, 2024. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic tape apparatus.

### 2. Description of the Related Art

There are two types of magnetic recording media: a tape shape and a disk shape, and a tape-shaped magnetic recording medium, that is, a magnetic tape is mainly used for data storage applications such as data backup and archiving (for example, see JP2016-524774A, US2019/0164573A1, and JP6590104B).

### SUMMARY OF THE INVENTION

Recording of data on a magnetic tape is usually performed by running the magnetic tape in a magnetic tape apparatus and recording the data on a data band by making a magnetic head follow the data band of the magnetic tape. Thereby, a data track is formed in the data band. In addition, in a case where the recorded data is reproduced, the data recorded on the data band is read by running the magnetic tape in the magnetic tape apparatus and by making the magnetic head follow the data band of the magnetic tape.

In order to increase an accuracy of the magnetic head following the data band of the magnetic tape in recording and/or reproduction as described above, a system for performing head tracking using a servo signal (hereinafter, it is described as a “servo system”) has been put into practical use.

Further, it has been proposed to acquire information on dimensions (contraction, extension, or the like) in a width direction of the magnetic tape during running by using a servo signal and to change an angle (hereinafter, also referred to as a “head tilt angle”) at which an axial direction of a module of a magnetic head is tilted against the width direction of the magnetic tape according to the acquired dimension information (see JP2016-524774A and US2019/0164573A1, for example, paragraphs 0059 to 0067 and 0084 of JP2016-524774A). During recording or reproduction, in a case where the magnetic head for recording or reproducing data records or reproduces data while being deviated from a target track position due to the width deformation of the magnetic tape, a phenomenon such as overwriting of recorded data or reproduction failure may occur. The present inventor considers that changing the head tilt angle as described above is one of means for suppressing the occurrence of such a phenomenon.

For example, assuming that the head tilt angle is changed as described above, it is desirable that running stability of the magnetic tape is high, in a case of recording and/or reproducing data by tilting an axial direction of a module of a magnetic head against the width direction of the magnetic tape (that is, tilting the head). This is because it is considered that the high running stability of the magnetic tape can lead to, for example, further suppressing the occurrence of the above phenomenon.

By the way, in recent years, the magnetic tape has been used in a data center where a temperature and a humidity are controlled.

On the other hand, the data center is required to save power in order to reduce costs. In order to save power, it is desirable that control conditions of the use environment of the magnetic tape in the data center can be more relaxed than a current level or the controlling can be made unnecessary.

However, in a case where the control conditions of the use environment are relaxed or the controlling is not performed, it is assumed that the magnetic tape may be used, for example, in a high temperature and high humidity environment. Therefore, a magnetic tape having excellent running stability in a case of recording and/or reproducing data by tilting the head in a high temperature and high humidity environment is desirable.

An object of one aspect of the present invention is to provide a magnetic tape having excellent running stability in a case of recording and/or reproduction by tilting a head in a high temperature and high humidity environment.

One aspect of the present invention is as follows.

[1] A magnetic tape comprising: a non-magnetic support; and a magnetic layer containing a ferromagnetic powder, in which a rate of change (hereinafter, also referred to as a “rate of change in protrusion area ratio”) in an area ratio of a protrusion (hereinafter, also referred to as a “protrusion area ratio”) having a height of 5 nm or more and 10 nm or less, which is obtained by measuring a measurement region of 5 μm×5 μm on a surface of the magnetic layer before and after 1000 reciprocating slides with respect to a linear tape-open (LTO) 8 head at a head tilt angle of 15° in an environment of a temperature of 35° C. and a relative humidity of 80%, with an atomic force microscope, is 10.0% or less.

[2] The magnetic tape according to [1], in which a dynamic frictional force F (hereinafter, also simply referred to as a “dynamic frictional force F”) during a 1000th forward path in the reciprocating slide is 15 gf or less.

[3] The magnetic tape according to [1] or [2], in which a coefficient of variation of an equivalent circle diameter of a bright region (hereinafter, also referred to as a “coefficient of variation of equivalent circle diameter of bright region”) in an image of a secondary electron image obtained by imaging the surface of the magnetic layer before the reciprocating slide with a scanning electron microscope at an acceleration voltage of 5 kV is 15.0% or less, the image being subjected to binarization processing, and a lower limit value of a threshold value in the binarization processing is 100 gradations and an upper limit value of the threshold value is 130 gradations.

[4] The magnetic tape according to any one of [1] to [3], in which the magnetic layer further contains a non-magnetic powder having a Mohs hardness of 6 or more and 7 or less.

[5] The magnetic tape according to any one of [1] to [4], further comprising: a non-magnetic layer containing a non-magnetic powder between the non-magnetic support and the magnetic layer.

[6] The magnetic tape according to any one of [1] to [5], further comprising: a back coating layer containing a non-magnetic powder on a surface side of the non-magnetic support opposite to a surface side having the magnetic layer.

[7] The magnetic tape according to any one of [1] to [6], in which a tape thickness of the magnetic tape is 5.0 μm or less.

[8] The magnetic tape according to any one of [1] to [7], in which a vertical squareness ratio of the magnetic tape is 0.60 or more.

[9] The magnetic tape according to any one of [1] to [8], in which a vertical squareness ratio of the magnetic tape is 0.65 or more.

[10] The magnetic tape according to any one of [1] to [9], in which the non-magnetic support is an aromatic polyamide support.

[11] The magnetic tape according to any one of [1] to [10], in which a dynamic frictional force F during a 1000th forward path in the reciprocating slide is 15 gf or less, a coefficient of variation of an equivalent circle diameter of a bright region in an image of a secondary electron image obtained by imaging the surface of the magnetic layer before the reciprocating slide with a scanning electron microscope at an acceleration voltage of 5 kV is 15.0% or less, the image being subjected to binarization processing, a lower limit value of a threshold value in the binarization processing is 100 gradations and an upper limit value of the threshold value is 130 gradations, the magnetic layer further contains a non-magnetic powder having a Mohs hardness of 6 or more and 7 or less, the magnetic tape further includes a non-magnetic layer containing a non-magnetic powder between the non-magnetic support and the magnetic layer, the magnetic tape further includes a back coating layer containing a non-magnetic powder on a surface side of the non-magnetic support opposite to a surface side having the magnetic layer, a tape thickness is 5.0 μm or less, and a vertical squareness ratio of the magnetic tape is 0.60 or more.

[12] A magnetic tape cartridge comprising: the magnetic tape according to any one of [1] to [11].

[13] A magnetic tape apparatus comprising: the magnetic tape according to any one of [1] to [11].

[14] The magnetic tape apparatus according to [13], further comprising: a magnetic head, in which the magnetic head has a module including an element array with a plurality of magnetic head elements between a pair of servo signal reading elements, and the magnetic tape apparatus changes an angle θ formed by an axis of the element array with respect to a width direction of the magnetic tape during running of the magnetic tape in the magnetic tape apparatus.

According to one aspect of the present invention, it is possible to provide a magnetic tape having excellent running stability in a case of recording and/or reproducing data by tilting a head in a high temperature and high humidity environment. In addition, according to one aspect of the present invention, it is possible to provide a magnetic tape cartridge and a magnetic tape apparatus which include the magnetic tape.

### BRIEF DESCRIPTION OF THE DRAWINGS

FIG. 1 is a schematic view showing an example of a module of a magnetic head.

FIG. 2 is an explanatory diagram of a relative positional relationship between a module and a magnetic tape during magnetic tape running in a magnetic tape apparatus.

FIG. 3 is an explanatory diagram relating to a change in an angle θ during magnetic tape running.

FIG. 4 shows an arrangement example of data bands and servo bands.

FIG. 5 shows an arrangement example of a servo pattern of an LTO Ultrium format tape.

FIG. 6 is an explanatory diagram of a measuring method of an angle θ during magnetic tape running.

FIG. 7 is a schematic view showing an example of the magnetic tape apparatus.

### DESCRIPTION OF THE PREFERRED EMBODIMENTS

### Magnetic Tape

One aspect of the present invention relates to a magnetic tape including a non-magnetic support and a magnetic layer containing a ferromagnetic powder. A rate of change in an area ratio of a protrusion (rate of change in protrusion area ratio) having a height of 5 nm or more and 10 nm or less, which is obtained by measuring a measurement region of 5 μm×5 μm on a surface of the magnetic layer before and after 1000 reciprocating slides with respect to an LTO 8 head at a head tilt angle of 15° in an environment of a temperature of 35° C. and a relative humidity of 80%, with an atomic force microscope, is 10.0% or less.

### Head Tilt Angle

Hereinafter, for describing the head tilt angle, first, the LTO 8 head will be described. Further, the reason why it is considered that the phenomenon occurring during the recording or during the reproduction described above can be suppressed by tilting the axial direction of the module of the magnetic head against the width direction of the magnetic tape during running of the magnetic tape will also be described below.

In the present invention and the present specification, the term “LTO 8 head” refers to a magnetic head conforming to an LTO 8 standard. As the LTO 8 head, a magnetic head mounted on an LTO 8 drive may be taken out and used, or a commercially available magnetic head as the magnetic head for the LTO 8 drive may be used. Here, the LTO 8 drive is a drive (magnetic tape apparatus) conforming to an LTO 8 standard. An LTO 9 drive is a drive conforming to an LTO 9 standard, and the same applies to drives of other generations. In addition, in a case where a plurality of magnetic tapes to be measured are reciprocally slid on the LTO 8 head at a head tilt angle of 15°, in measurement of each magnetic tape, a new (that is, unused) LTO 8 head is used, respectively. In consideration of the fact that the LTO 8 standard is a standard that can cope with high-density recording in recent years, the LTO 8 is employed as a head, and the magnetic tape is not limited to the one used in the LTO 8 drive. On the magnetic tape, data may be recorded and/or reproduced in the LTO 8 drive, data may be recorded and/or reproduced in the LTO 9 drive or even a next generation drive, or data may be recorded and/or reproduced in a drive of a generation prior to the LTO 8 drive, such as LTO 7.

The LTO 8 head has three modules including an element array with a plurality of magnetic head elements between a pair of servo signal reading elements. The three modules are arranged in the LTO 8 head in arrangement of “recording module-reproducing module-recording module” (total number of modules: 3).

Each module includes an element array with a total of 32 magnetic head elements between a pair of servo signal reading elements, that is, an arrangement of the elements. A module having a recording element as the magnetic head element is a recording module for recording data on the magnetic tape. A module having a reproducing element as the magnetic head element is a reproducing module for reproducing data recorded on the magnetic tape. In the LTO 8 head, three modules are arranged such that axes of the element arrays of the respective modules are oriented in parallel. Such a term “parallel” does not necessarily mean only parallel in a strict sense, but includes a range of errors normally allowed in the technical field to which the present invention belongs. The range of errors can mean, for example, a range less than strictly parallel±10°.

The head tilt angle in 1000 reciprocating slides is a head tilt angle of the LTO 8 head in the reproducing module.

In each element array, the pair of servo signal reading elements and the plurality of magnetic head elements (that is, the recording element or the reproducing element) are arranged linearly to be spaced from each other. Here, the term “arranged linearly” means that each magnetic head element is arranged on a straight line connecting a central portion of one servo signal reading element and a central portion of the other servo signal reading element. The term “axis of the element array” in the present invention and the present specification means a straight line connecting a central portion of one servo signal reading element and a central portion of the other servo signal reading element.

Next, a configuration of a module and the like will be further described with reference to the drawings. Note that the form shown in the drawings is an example and does not limit the present invention.

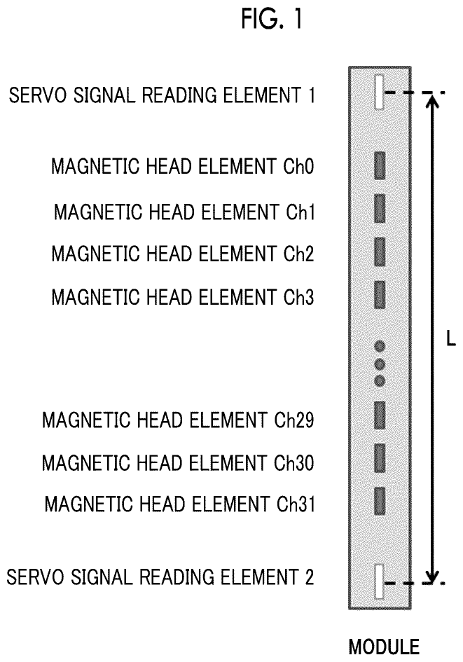

FIG. 1 is a schematic view showing an example of the module of the magnetic head. The module shown in FIG. 1 has a plurality of magnetic head elements between a pair of servo signal reading elements (servo signal reading elements 1 and 2). The magnetic head element is also referred to as a “channel”. “Ch” in the figure is an abbreviation for channel. The module shown in FIG. 1 has a total of 32 magnetic head elements from Ch0 to Ch31. A reproducing module of the LTO 8 head has a total of 32 reproducing elements from Ch0 to Ch31.

In FIG. 1, “L” represents a distance between a pair of servo signal reading elements, that is, a distance between one servo signal reading element and the other servo signal reading element. In the module shown in FIG. 1, “L” represents a distance between the servo signal reading element 1 and the servo signal reading element 2. Specifically, it is a distance between a central portion of the servo signal reading element 1 and a central portion of the servo signal reading element 2. Such a distance can be measured, for example, by an optical microscope or the like.

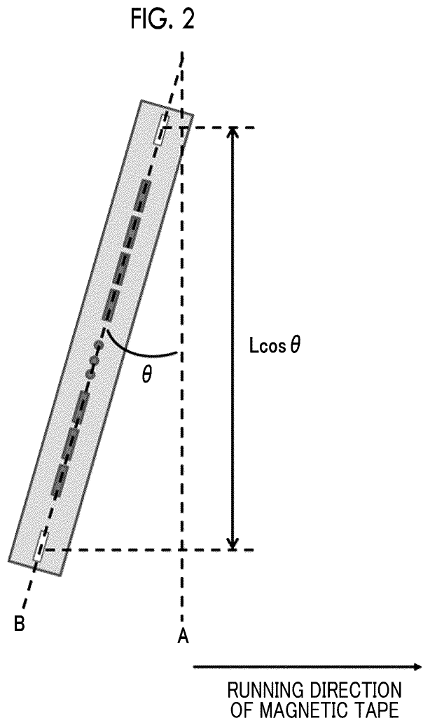

FIG. 2 is an explanatory diagram of a relative positional relationship between the module and the magnetic tape during running of the magnetic tape in the magnetic tape apparatus. In FIG. 2, the dotted line A indicates the width direction of the magnetic tape. The dotted line B indicates the axis of the element array. The angle θ can be said to be a head tilt angle during running of the magnetic tape, and is an angle formed by the dotted line A and the dotted line B. In a case where the angle θ is 0° during running of the magnetic tape, a distance in the magnetic tape width direction between one servo signal reading element and the other servo signal reading element in the element array (hereinafter, also referred to as “effective distance between servo signal reading elements”) is “L”. On the other hand, in a case where the angle θ exceeds 0°, the effective distance between the servo signal reading elements is “L cos θ”, where Lcosθ is smaller than L. That is, “L cos θ<L”.

As described above, during recording or reproduction, in a case where the magnetic head for recording or reproducing data records or reproduces data while being deviated from a target track position due to the width deformation of the magnetic tape, a phenomenon such as overwriting of recorded data or reproduction failure may occur. For example, in a case where the width of the magnetic tape contracts or expands, a phenomenon may occur in which the magnetic head element, which should perform recording or reproduction at a target track position, performs recording or reproduction at a different track position. In addition, in a case where the width of the magnetic tape expands, a phenomenon may occur in which the effective distance between the servo signal reading elements becomes shorter than an interval between two servo bands adjacent to each other with the data band interposed therebetween (also referred to as “servo band interval” or “interval between servo bands”, specifically, a distance between the two servo bands in the width direction of the magnetic tape), and data is not recorded or reproduced in a portion near an edge of the magnetic tape.

On the other hand, in a case where the element array is tilted at an angle θ exceeding 0°, the effective distance between the servo signal reading elements becomes “L cos θ” as described above. The larger the value of θ, the smaller the value of L cos θ, and the smaller the value of θ, the larger the value of L cos θ. Therefore, by changing the value of θ according to a degree of the dimension change (that is, contraction or extension) in the width direction of the magnetic tape, it is possible to make the effective distance between the servo signal reading elements approximate to or match with the interval between the servo bands. As a result, it is possible to prevent a phenomenon such as overwriting of recorded data or reproduction failure due to the fact that the magnetic head for recording or reproducing data records or reproduces data while being deviated from a target track position due to the width deformation of the magnetic tape during recording or reproduction, or to reduce a frequency of the occurrence of the phenomenon.

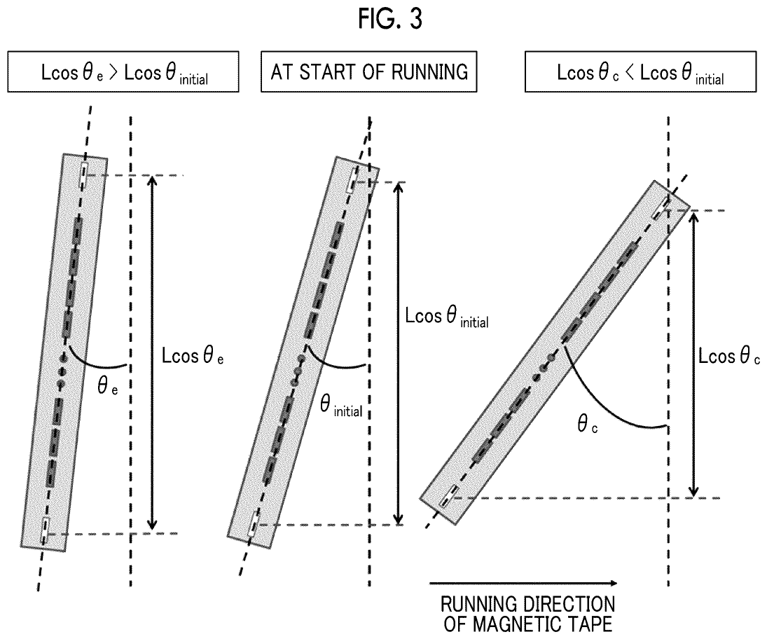

FIG. 3 is an explanatory diagram relating to a change in the angle θ during running of the magnetic tape.

θᵢₙᵢₜᵢₐₗ, which is an angle θ at the start of running, can be set to, for example, 0° or more or more than 0°.

In FIG. 3, the central figure shows a state of the module at the start of running.

In FIG. 3, the right figure shows a state of the module in a case where the angle θ is set to an angle θ_{c}, which is an angle larger than θᵢₙᵢₜᵢₐₗ. The effective distance between the servo signal reading elements L cos θ_{c} is a value smaller than L cos θᵢₙᵢₜᵢₐₗ at the start of running of the magnetic tape. In a case where the width of the magnetic tape contracts during running of the magnetic tape, it is preferable to perform such angle adjustment.

On the other hand, in FIG. 3, the left figure shows a state of the module in a case where the angle θ is set to an angle De, which is an angle smaller than θᵢₙᵢₜᵢₐₗ. The effective distance between the servo signal reading elements L cos θe is a value larger than L cos θᵢₙᵢₜᵢₐₗ at the start of running of the magnetic tape. In a case where the width of the magnetic tape expands during running of the magnetic tape, it is preferable to perform such angle adjustment.

As described above, changing the head tilt angle during running of the magnetic tape can contribute to prevention of the phenomenon such as overwriting of recorded data or reproduction failure due to the fact that the magnetic head for recording or reproducing data records or reproduces data while being deviated from a target track position due to the width deformation of the magnetic tape during recording or reproduction, or can contribute to reduction of the frequency of the occurrence of the phenomenon.

Meanwhile, recording of data on the magnetic tape and reproduction of the recorded data are usually performed by running the magnetic tape to slide the magnetic layer surface and the magnetic head on each other. The present inventor considered that, in a case where the magnetic tape is made to run with the head tilted during such a recording and/or reproduction, a contact state between the magnetic head and the magnetic layer surface becomes unstable, which can be a factor in decreasing running stability.

Based on the above supposition, the present inventor has made extensive studies. As a result, the present inventor has newly found that the magnetic tape in which the rate of change in protrusion area ratio is 10.0% or less can exhibit excellent running stability in a case where the data is recorded and/or reproduced by tilting the head in a high temperature and high humidity environment. The temperature and humidity of a measurement environment are employed as exemplary values of the temperature and humidity of the high temperature and high humidity environment. Therefore, an environment in which data is recorded on the magnetic tape and the recorded data is reproduced is not limited to the temperature and humidity environment. The head tilt angle was also employed as an exemplary value of the angle that could be employed in recording and/or reproducing data by changing the head tilt angle during running of the magnetic tape. Therefore, the head tilt angle in a case where data is recorded on the magnetic tape and the recorded data is reproduced is also not limited to the angle described above. In addition, the present invention is not limited by supposition of the present inventor described in the present specification.

In the present specification, the running stability in a case of performing the recording and/or reproducing of data by tilting the head during the running of the magnetic tape in the high temperature and high humidity environment is also simply referred to as “running stability”. In addition, the high temperature and high humidity environment may be, for example, an environment having a temperature of about 30° C. to 50° C. A humidity of the environment may be, for example, about 70% to 100% as a relative humidity. In the present invention and the present specification, the temperature and humidity described for an environment are an atmosphere temperature and a relative humidity of the environment.

In the present invention and the present specification, 1000 reciprocating slides with respect to the LTO 8 head at a head tilt angle of 15° in an environment of a temperature of 35° C. and a relative humidity of 80% are performed by the following method using a magnetic tape to be measured.

In addition, the head tilt angle (15°) refers to an angle formed by the axis of the element array of the reproducing module of the LTO 8 head with respect to a direction orthogonal to a sliding direction during a first forward path of the following 1000 reciprocating slides. Such an angle is an angle θ formed by A and B in a case where A in FIG. 2 is read as the direction orthogonal to the sliding direction. The head tilt angle is fixed during the 1000 reciprocating slides.

The magnetic tape to be measured is placed on two cylindrical guide rolls having a diameter of 1 inch (1 inch=2.54 cm) spaced apart from each other and arranged in parallel with each other such that the magnetic layer surface thereof is in contact with the guide rolls. Before starting the reciprocating slide, the magnetic tape to be measured is placed on the guide roll as described above and left for 24 hours or more in order to be adapted to the environment (temperature of 35° C., relative humidity of 80%).

In a randomly selected portion of the magnetic tape to be measured, the magnetic layer surface of the magnetic tape is slid with respect to the LTO 8 head with the head tilt angle as 15°, and the reciprocating slide is performed 1000 times. Regarding sliding conditions, a wrap angle θ is 6° and a sliding speed is 30 mm/sec. A tension applied in the longitudinal direction of the magnetic tape during the sliding is set to 0.55 N. A sliding distance for each of a forward path and a return path is set to 5 cm. One end of both ends of the magnetic tape to be measured in the longitudinal direction is connected to the strain gauge, and a tension of 0.20 N is applied to the other end. In a case of measuring the dynamic frictional force F, a resistance force generated during the sliding is detected by a strain gauge. Assuming that the tension applied here is T₀ (unit: N) and the resistance force detected by the strain gauge is T (unit: N), the dynamic frictional force F is calculated by the following equation. That is, here, the dynamic frictional force F is calculated as T₀=0.20. A dynamic frictional force during the 1000th forward path is defined as a “dynamic frictional force F”. Regarding a unit of the dynamic frictional force F, “gf” indicates gram-force, and 1 N (Newton) is about 102 gf.

$$F = T - {T}_{0}$$

### Rate of Change in Protrusion Area Ratio

In the magnetic tape, a rate of change in an area ratio of a protrusion (rate of change in protrusion area ratio) having a height of 5 nm or more and 10 nm or less, which is obtained by measuring a measurement region of 5 μm×5 μm on a surface of the magnetic layer before and after 1000 reciprocating slides with respect to an LTO 8 head at a head tilt angle of 15° in an environment of a temperature of 35° C. and a relative humidity of 80%, with an atomic force microscope, is 10.0% or less. In the present invention and the present specification, the term “magnetic layer surface (surface of the magnetic layer)” has the same meaning as the surface of the magnetic tape on the magnetic layer side.

In the present invention and the present specification, the rate of change in protrusion area ratio is obtained by measurement using an atomic force microscope (AFM). The measurement region is a 5 μm square (5 μm×5 μm) per point. The measurement is carried out in two measurement regions randomly selected on the magnetic layer surface subjected to the 1000 reciprocating slides. The measurement is also carried out in two measurement regions randomly selected on the magnetic layer surface not subjected to the 1000 reciprocating slides. The area ratio of the protrusion (protrusion area ratio) having a height of 5 nm or more and 10 nm or less is calculated from the AFM measurement data of each measurement region (5 μm×5 μm). The protrusion area ratio is a ratio of the total area of the protrusion having a height of 5 nm or more and 10 nm or less to the total area of the measurement region (that is, 5 μm×5 μm=25 μm²), and is calculated according to the following equation. For the protrusion having a height of 5 nm or more and 10 nm or less, in which only a part of the protrusion is present in the measurement region and the remaining part is present outside the measurement region, the area of the part present in the measurement region is included in the area for calculating the area ratio, and the area of the part present outside the measurement region is not included in the area for calculating the area ratio.

$$Protrusion area ratio ( \% ) = 100 \times “ total area of protrusion having height of 5 nm or more and 10 nm or less ” / total area of measurement region$$

The arithmetic average of the protrusion area ratios obtained for the two measurement regions of the magnetic layer surface subjected to the 1000 reciprocating slides is adopted as the protrusion area ratio after the reciprocating slide.

The arithmetic average of the protrusion area ratios obtained for the two measurement regions of the magnetic layer surface not subjected to the 1000 reciprocating slides is adopted as the protrusion area ratio before the reciprocating slide.

The rate of change in protrusion area ratio is calculated by the following equation.

$$Rate of change in protusion area ratio ( \% ) = 100 \times ( protusion area ratio before reciprocating slide - protrusion area ratio after reciprocating slide ) / protrusion area ratio before reciprocating slide$$

Examples of the AFM data analysis software include AFM data analysis software (Nanoscope Analysis) provided by BRUKER. As the AFM, for example, Nanoscope 5 manufactured by BRUKER can be used. The following measurement conditions can be used as the measurement conditions of the AFM. In order to obtain the rate of change in protrusion area ratio described in the section of Examples described later, Nanoscope 5 manufactured by BRUKER was used as an AFM, AFM data analysis software (Nanoscope Analysis) provided by BRUKER was used as AFM data analysis software, and the measurement was performed by adopting the following measurement conditions.

### Measurement Conditions

Measurement environment: temperature 23° C., relative humidity 50%
Measurement area: 5 μm×5 μm
Measurement surface: magnetic layer surface
Resolution: 512 pixels×512 pixels
Scan rate: 3 μm/sec
Set point: 100 nN
AFM probe: SI-AF01 (manufactured by Hitachi High-Tech Corporation)
Number of measurements: N=2 before reciprocating slide and after reciprocating slide, respectively

The magnetic tape in which the rate of change in protrusion area ratio is 10.0% or less can exhibit excellent running stability in a case of recording and/or reproduction by tilting the head in a high temperature and high humidity environment. The present inventor supposes that the reason why excellent running stability can be exhibited is that, in the magnetic tape in which the rate of change in protrusion area ratio is 10.0% or less, it is possible to suppress an increase in the dynamic frictional force F in a case where the head is tilted and the running is repeated. The reason why the rate of change in protrusion area ratio of the magnetic tape is set to 10.0% or less is that, in the course of extensive studies by the present inventor, a phenomenon in which an increase in the dynamic frictional force F in a case where the head is tilted and the running is repeated is remarkable is confirmed in a case where the rate of change in protrusion area ratio exceeds 10.0%. From the viewpoint of further suppressing an increase in dynamic frictional force F and further improving running stability, the rate of change in protrusion area ratio is preferably 9.0% or less, and more preferably 8.0% or less, 7.0% or less, 6.0% or less, and 5.0% or less in this order. The rate of change in protrusion area ratio can be, for example, 0.0% or more, more than 0.0%, 0.1% or more, 1.0% or more, or 2.0% or more. The present inventor considers that the smaller the value of the rate of change in protrusion area ratio, the more preferable it is from the viewpoint of improving running stability.

### Dynamic Frictional Force F

The dynamic frictional force F during the 1000th forward path in the 1000 reciprocating slides of the magnetic tape is preferably 15 gf or less, more preferably 12 gf or less, and still more preferably 10 gf or less, 8 gf or less, and 6 gf or less in this order. The dynamic frictional force F may be, for example, 4 gf or more, and may be less than the values exemplified here.

By controlling the rate of change in protrusion area ratio to 10.0% or less, the dynamic frictional force F can be controlled to 15 gf or less. Specific examples of the means for controlling the rate of change in protrusion area ratio to 10.0% or less will be described later.

Hereinafter, the magnetic tape will be described in more detail.

### Magnetic Layer

### Ferromagnetic Powder

As a ferromagnetic powder included in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

### Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single structure is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a prascodymium atom (Pr), a neodymium atom (Nd), a promethium atom (Pm), a samarium atom (Sm), a curopium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for manufacturing a magnetic tape exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

$$Hc = 2 Ku / Ms \{ 1 - {[ ( kT / KuV ) ln ( At \text{/0.693} ) ]}^{1 / 2} \}$$

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)|

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. The “rare earth atom surface layer portion uneven distribution property” of the present invention and the present specification means that a rare earth atom content with respect to 100 at % of iron atom in a solution obtained by partially dissolving the hexagonal strontium ferrite powder with acid (hereinafter, referred to as a “rare earth atom surface layer portion content” or simply a “surface layer portion content” regarding the rare earth atom) and a rare earth atom content with respect to 100 at % of iron atom in a solution obtained by totally dissolving the hexagonal strontium ferrite powder with acid (hereinafter, referred to as a “rare earth atom bulk content” or simply a “bulk content” regarding the rare earth atom) satisfy a ratio of a rare earth atom surface layer portion content/a rare earth atom bulk content >1.0.

A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, os is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. 1 [kOe] is 10⁶/4π [A/m].

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M type hexagonal ferrite is represented by a composition formula of AFe₁₂O¹⁹. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

### Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

ε-Iron oxide powder

Preferred specific examples of the ferromagnetic powder include an ε-iron oxide powder. In the present invention and the present specification, the term “ε-iron oxide powder” refers to a ferromagnetic powder in which an ε-iron oxide crystal structure is detected as a main phase by X-ray diffraction analysis. For example, in a case where the highest intensity diffraction peak is attributed to an ε-iron oxide crystal structure in an X-ray diffraction spectrum obtained by X-ray diffraction analysis, it is determined that the ε-iron oxide crystal structure is detected as the main phase. As a method of manufacturing an ε-iron oxide powder, a manufacturing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in one aspect, σs of the ε-iron oxide powder may be 8 A·m²/kg or more, and may be 12 A·m²/kg or more. On the other hand, from the viewpoint of noise reduction, os of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, a contour of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be employed, for example.

In the present invention and the present specification, unless otherwise noted,
(1) in a case where the shape of the particle observed in the particle image described above is a needle shape, a fusiform shape, or a columnar shape (here, a height is greater than a maximum major diameter of a bottom surface), the size (particle size) of the particles configuring the powder is shown as a length of a long axis configuring the particle, that is, a long axis length,
(2) in a case where the shape of the particle is a plate shape or a columnar shape (here, a thickness or a height is smaller than a maximum major diameter of a plate surface or a bottom surface), the particle size is shown as a maximum major diameter of the plate surface or the bottom surface, and
(3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. A high filling percentage of the ferromagnetic powder in the magnetic layer is preferable from the viewpoint of improving the recording density.

### Binding Agent

The magnetic tape can be a coating type magnetic tape, and include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to.

An average molecular weight of the resin used as the binding agent can be, for example, 10,000 to 200,000 as a weight-average molecular weight. The weight-average molecular weight of the present invention and the present specification is a value obtained by performing polystyrene conversion of a value measured by gel permeation chromatography (GPC) under the following measurement conditions. The weight-average molecular weight of the binding agent shown in the section of Examples described below is a value obtained by performing polystyrene conversion of a value measured under the following measurement conditions. The binding agent may be used in an amount of, for example, 1.0 to 30.0 parts by mass with respect to 100.0 parts by mass of the ferromagnetic powder.
GPC device: HLC-8120 (manufactured by Tosoh Corporation)
Column: TSK gel Multipore HXL-M (manufactured by Tosoh Corporation, 7.8 mm inner diameter (ID)×30.0 cm)
Eluent: tetrahydrofuran (THF)

### Curing Agent

A curing agent can also be used together with the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in the manufacturing step of the magnetic tape, whereby at least a part of the curing agent can be included in the magnetic layer in a state of being reacted (crosslinked) with other components such as the binding agent. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in the composition for forming a magnetic layer in an amount of, for example, 0 to 80.0 parts by mass, and preferably 50.0 to 80.0 parts by mass from the viewpoint of improving a strength of each layer such as the magnetic layer, with respect to 100.0 parts by mass of the binding agent.

### Other Components

The magnetic layer may include one or more kinds of additives, as necessary. As the additive, a commercially available product can be appropriately selected and used according to a desired property. Alternatively, a compound synthesized by a well-known method can be used as the additive. Examples of the additive include the curing agent described above. In addition, examples of the additive which can be included in the magnetic layer include a non-magnetic powder, a lubricant, a dispersing agent, a dispersing assistant, an antibacterial agent, an antistatic agent, and an antioxidant. Examples of the non-magnetic powder include a non-magnetic powder capable of functioning as a protrusion forming agent and a non-magnetic powder capable of functioning as an abrasive. Further, as the additive, well-known additives such as various polymers disclosed in paragraphs 0030 to 0080 of JP2016-051493A can also be used.

In one aspect, the magnetic tape can include one or more fatty acid compounds selected from the group consisting of a fatty acid, a fatty acid ester, and a fatty acid amide in a portion on the non-magnetic support on the magnetic layer side. In the present invention and the present specification, the term “portion on the non-magnetic support on the magnetic layer side” refers to a magnetic layer in a case of a magnetic recording medium including the magnetic layer directly on the non-magnetic support, and refers to a magnetic layer and/or a non-magnetic layer in a case of a magnetic recording medium including the non-magnetic layer between the non-magnetic support and the magnetic layer. The term “portion on the non-magnetic support on the magnetic layer side” is also simply described as a “portion on the magnetic layer side”. The presence of a certain component on the surface of the magnetic tape on the magnetic layer side is also included in the inclusion of the component in the portion on the magnetic layer side. The above-described fatty acid compound can function as a lubricant. The portion on the magnetic layer side may contain only one fatty acid compound selected from the group consisting of a fatty acid, a fatty acid ester, and a fatty acid amide, or may contain two or more components. In addition, only one or two or more fatty acids may be contained as the fatty acid. The same applies to the fatty acid ester and the fatty acid amide.

Examples of the fatty acid include lauric acid, myristic acid, palmitic acid, stearic acid, oleic acid, linoleic acid, linolenic acid, behenic acid, erucic acid, elaidic acid, stearic acid, myristic acid, and palmitic acid are preferable, and stearic acid is more preferable. The fatty acid may be included in the magnetic layer in a form of a salt such as a metal salt.

Examples of the fatty acid ester include butyl hexanoate, butyl octanoate, butyl decanoate, butyl laurate, butyl myristate, and butyl palmitate. The present inventor supposes that the use of a fatty acid ester having a small number of carbon atoms in the fatty acid moiety as the fatty acid ester can contribute to reducing the value of the rate of change in protrusion area ratio. From this point, as the fatty acid ester, a fatty acid ester having 16 or less carbon atoms in the fatty acid moiety is preferable. For example, the number of carbon atoms in the fatty acid moiety of butyl palmitate is 16. The number of carbon atoms in the fatty acid moiety may be, for example, 6 or more and 16 or less.

Examples of the fatty acid amide include amides of the above-described exemplified various fatty acids. Specific examples thereof include lauric acid amide, myristic acid amide, palmitic acid amide, and stearic acid amide.

In one aspect, the magnetic recording medium including one or more fatty acid compounds selected from the group consisting of a fatty acid, a fatty acid ester, and a fatty acid amide in the portion on the magnetic layer side can be manufactured by forming the magnetic layer using the composition for forming a magnetic layer containing one or more of the above fatty acid compounds. In addition, in one aspect, the magnetic recording medium including one or more of the fatty acid compounds in the portion on the magnetic layer side can be manufactured by forming the non-magnetic layer using the composition for forming a non-magnetic layer containing one or more of the above fatty acid compounds. In addition, in one aspect, the magnetic recording medium including one or more of the fatty acid compounds in the portion on the magnetic layer side can be manufactured by forming the non-magnetic layer using the composition for forming a non-magnetic layer containing one or more of the above fatty acid compounds and the magnetic layer using the composition for forming a magnetic layer containing one or more of the above fatty acid compounds. The non-magnetic layer can play a role of holding a component that can function as a lubricant such as a fatty acid, a fatty acid ester, and a fatty acid amide, and supplying the component to the magnetic layer. The lubricant such as a fatty acid, a fatty acid ester, and a fatty acid amide included in the non-magnetic layer may be transferred to the magnetic layer and present in the magnetic layer.

A content of the fatty acid in the magnetic layer or the composition for forming a magnetic layer is, for example, 0 to 3.0 parts by mass, and preferably 0.5 to 3.0 parts by mass per 100.0 parts by mass of the ferromagnetic powder.

A content of the fatty acid ester in the magnetic layer or the composition for forming a magnetic layer is, for example, 0 to 10.0 parts by mass, and preferably 0.5 to 7.0 parts by mass per 100.0 parts by mass of the ferromagnetic powder.

A content of the fatty acid amide in the magnetic layer or the composition for forming a magnetic layer is, for example, 0 to 1.0 part by mass, and preferably 0.1 to 1.0 part by mass per 100.0 parts by mass of the ferromagnetic powder.

Regarding contents of the fatty acid, the fatty acid ester, and the fatty acid amide in the non-magnetic layer or the composition for forming a non-magnetic layer, the above description can be applied by replacing the ferromagnetic powder with the non-magnetic powder.

As the protrusion forming agent which is one aspect of the non-magnetic powder, a particle of an inorganic substance can be used, a particle of an organic substance can be used, and a composite particle of an inorganic substance and an organic substance can also be used. Examples of the inorganic substance include an inorganic oxide such as metal oxide, metal carbonate, metal sulfate, metal nitride, metal carbide, and metal sulfide, and an inorganic oxide is preferable. In one aspect, the protrusion forming agent may be an inorganic oxide-based particle. Here, the term “-based” is used to mean “including”. In one aspect, as the protrusion forming agent, non-magnetic colloidal particles can be exemplified. In the present invention and the present specification, the “colloidal particles” refer to particles which are dispersed without precipitation to generate a colloidal dispersion, in a case where 1 g of the particles is added to 100 mL of at least one organic solvent of methyl ethyl ketone, cyclohexanone, toluene, or ethyl acetate, or a mixed solvent including two or more kinds of the solvent described above at an optional mixing ratio. The non-magnetic colloidal particles are preferably inorganic colloidal particles, more preferably inorganic oxide colloidal particles, and particularly preferably silica colloidal particles (colloidal silica) from the viewpoint of availability of monodispersed colloidal particles.

An average particle size of the protrusion forming agent may be, for example, 30 to 300 nm, and preferably 40 to 200 nm.

From the viewpoint of reducing the value of the rate of change in protrusion area ratio, it is preferable that the non-magnetic powder having a Mohs hardness of 6 or more and 7 or less is included in the magnetic layer. Such a non-magnetic powder can function as a protrusion forming agent. The Mohs hardness is a well-known physical property value, and the maximum value of the Mohs hardness is 10 for diamond. The Mohs hardness of the various non-magnetic powders is a well-known value in the literature or can be measured by a well-known method.

The abrasive, which is another aspect of the non-magnetic powder is preferably a non-magnetic powder having a Mohs hardness of more than 8, and more preferably a non-magnetic powder having a Mohs hardness of 9 or more. Specifically, as the abrasive, powders of alumina (for example, Al₂O₃), silicon carbide, boron carbide (for example, B₄C), SiO₂, TiC, chromium oxide (Cr₂O₃), cerium oxide, zirconium oxide (for example, ZrO₂), iron oxide, diamond, and the like can be used, and among these, alumina powder such as α-alumina and silicon carbide powder are preferable. In addition, the average particle size of the abrasive may be, for example, in a range of 30 to 300 nm, and preferably in a range of 50 to 200 nm.

In addition, from the viewpoint that the protrusion forming agent and the abrasive can exhibit their functions more effectively, the content amount of the protrusion forming agent in the magnetic layer is preferably 0.1 to 4.0 parts by mass and more preferably 0.3 to 3.5 parts by mass with respect to 100.0 parts by mass of the ferromagnetic powder. According to the study by the present inventor, in a case where the content of the protrusion forming agent in the magnetic layer is increased, a tendency is observed in which the value of the rate of change in protrusion area ratio is small. On the other hand, the content of the abrasive in the magnetic layer is preferably 1.0 to 20.0 parts by mass, more preferably 3.0 to 15.0 parts by mass, and still more preferably 4.0 to 10.0 parts by mass with respect to 100.0 parts by mass of the ferromagnetic powder.

As an example of the additive that can be used in the magnetic layer containing the abrasive, a dispersing agent disclosed in paragraphs 0012 to 0022 of JP2013-131285A can be used as a dispersing agent for improving the dispersibility of the abrasive in the composition for forming a magnetic layer. In addition, for the dispersing agent, descriptions disclosed in paragraphs 0061 and 0071 of JP2012-133837A can be referred to. The dispersing agent may be contained in the non-magnetic layer. For the dispersing agent which may be contained in the non-magnetic layer, a description disclosed in a paragraph 0061 of JP2012-133837A can be referred to.

### Coefficient of Variation of Equivalent Circle Diameter of Bright Region

In one aspect, in the magnetic tape, it is preferable that a coefficient of variation of an equivalent circle diameter of a bright region (coefficient of variation of equivalent circle diameter of bright region) in an image of a secondary electron image obtained by imaging the surface of the magnetic layer before the reciprocating slide described above, that is, not subjected to the reciprocating slide described above, with a scanning electron microscope at an acceleration voltage of 5 kV is 15.0% or less, the image being subjected to binarization processing. Here, a lower limit value of a threshold value in the binarization processing is 100 gradations and an upper limit value thereof is 130 gradations.

In the present invention and the present specification, a scanning electron microscope (SEM) used to obtain the coefficient of variation of equivalent circle diameter of bright region is a field emission-scanning electron microscope (FE-SEM). As the FE-SEM, for example, FE-SEM S4800 manufactured by Hitachi, Ltd. can be used, and this FE-SEM was used in the measurement described in the section of Examples described below.

In order to obtain the coefficient of variation of equivalent circle diameter of bright region, a coating treatment on the magnetic layer surface is not performed before an SEM image is captured. Imaging is performed by selecting a non-imaging region on the magnetic layer surface. The SEM image to be captured is a secondary electron image.

The equivalent circle diameter may be obtained in 1 nm increments by rounding off the first decimal point and rounding down the second decimal point. In a case of obtaining the coefficient of variation of equivalent circle diameter of bright region, a bright region in which only a part is included in the binarized image and the remaining part is outside the binarized image is excluded from the measurement target.

The coefficient of variation of equivalent circle diameter of bright region is obtained by the following method.

A secondary electron image of the magnetic layer surface of the magnetic tape to be measured is captured using a scanning electron microscope (FE-SEM). The measurement point is set to one randomly selected point. The imaging is performed on the magnetic layer surface that is not subjected to the reciprocating slide described above. As imaging conditions, an acceleration voltage is 5 kV, an operating distance is 8 mm, and an imaging magnification is 10000×. In imaging, a non-imaging region on the magnetic layer surface is selected, focus adjustment is performed under the imaging conditions, and a secondary electron image is captured. A part (micron bar, cross mark, or the like) for displaying the size and the like is erased from the captured image, and a secondary electron image having the number of pixels of 960 pixels×1280 pixels is acquired.

The secondary electron image thus acquired is taken into image processing software, and is binarized by the following procedure. As image analysis software, for example, free software ImageJ can be used. The image is divided into a bright region (white part) and a dark region (black part) by binarization processing.

For a threshold value for binarizing the secondary electron image acquired above, a lower limit value is set to 100 gradations and an upper limit value is set to 130 gradations, and the binarization processing is executed based on these two threshold values. After the binarization processing, noise component removal processing is performed by the image analysis software. The noise component removal processing can be performed by the following method, for example. In the image analysis software ImageJ, noise cut processing Despeckle is selected to remove the noise component.

For the binarized image thus obtained, the area of each of a plurality of bright regions (that is, white parts) included in the binarized image is obtained by the image analysis software. From the area of the bright region obtained here, the equivalent circle diameter of each bright region is obtained. Specifically, an equivalent circle diameter L is calculated from an obtained area A by 2×(A/π)\hat{ }(½)=L. Here, the symbol “\hat{ }” represents a power.

The coefficient of variation of equivalent circle diameter is calculated from the standard deviation σ and the arithmetic average of the equivalent circle diameters L obtained as described above, according to the following equation.

$$Coefficient of variation of equivalent circle diameter ( \% ) = 100 \times standard deviation / arithmetic average$$

The present inventor considers that the coefficient of variation of equivalent circle diameter of bright region can be an index of the existence state of the protrusion forming agent in the magnetic layer in a state where the reciprocating slide has not been performed. The present inventor speculates that the existence of the protrusion forming agent in a state where the coefficient of variation of equivalent circle diameter of such a bright region is 15.0% or less can contribute to reducing the value of the rate of change in protrusion area ratio. From the viewpoint of further reducing the value of the rate of change in protrusion area ratio, the coefficient of variation of equivalent circle diameter of bright region is still more preferably 14.0% or less, and still more preferably 13.0% or less and 12.0% or less in this order. The coefficient of variation of equivalent circle diameter of bright region may be, for example, 1.0% or more, 2.0% or more, 3.0% or more, 4.0% or more, 5.0% or more, 6.0% or more, 7.0% or more, or 8.0% or more. It is considered that the smaller the value of the coefficient of variation of equivalent circle diameter of bright region, the more preferable it is to make the value of the rate of change in protrusion area ratio smaller. Therefore, the coefficient of variation of equivalent circle diameter of bright region may be less than the values exemplified here. In order to reduce the value of the coefficient of variation of equivalent circle diameter of bright region, it is preferable to use colloidal particles as the protrusion forming agent.]

Non-magnetic layer

Next, the non-magnetic layer will be described. The above magnetic tape may have a magnetic layer directly on the non-magnetic support, or may have a non-magnetic layer including a non-magnetic powder between the non-magnetic support and the magnetic layer. The non-magnetic powder used for the non-magnetic layer may be an inorganic substance powder (inorganic powder) or an organic substance powder (organic powder). In addition, the carbon black and the like can be used. Examples of the inorganic substance include metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 mass % and more preferably in a range of 60 to 90 mass %, with respect to the total mass of the non-magnetic layer.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The non-magnetic layer of the magnetic tape also includes a substantially non-magnetic layer including a small amount of ferromagnetic powder as impurities, for example, or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and coercivity.

### Non-Magnetic Support

Next, the non-magnetic support will be described. Examples of the non-magnetic support (hereinafter, also simply referred to as a “support”) include well-known components such as polyethylene terephthalate, polyethylene naphthalate, polyamide, polyamideimide, and aromatic polyamide subjected to biaxial stretching. Among these, polyethylene terephthalate, polyethylene naphthalate, and polyamide are preferable. A corona discharge, a plasma treatment, an easy-bonding treatment, or a heat treatment may be performed on these supports in advance.

In one aspect, the non-magnetic support of the magnetic tape can be an aromatic polyester support. In the present invention and the present specification, the term “aromatic polyester” means a resin containing an aromatic skeleton and a plurality of ester bonds, and the “aromatic polyester support” means a support containing at least one aromatic polyester film. The term “aromatic polyester film” refers to a film in which a component that accounts for the largest amount on a mass basis among components constituting the film is an aromatic polyester. The term “aromatic polyester support” in the present invention and the present specification includes those in which all resin films contained in the support are aromatic polyester films, and those containing the aromatic polyester film and another resin film. Specific examples of the aromatic polyester support include a single aromatic polyester film, a laminated film of two or more layers of the aromatic polyester film having the same constituent component, a laminated film of two or more layers of the aromatic polyester film having different constituent components, and a laminated film including one or more layers of the aromatic polyester film and one or more layers of resin film other than the aromatic polyester. An adhesive layer or the like may be optionally included between two adjacent layers in the laminated film. The aromatic polyester support may optionally include a metal film and/or a metal oxide film formed on one or both surfaces by vapor deposition or the like. The same applies to a “polyethylene terephthalate support” and a “polyethylene naphthalate support” in the present invention and the present specification.

An aromatic ring contained in the aromatic skeleton of the aromatic polyester is not particularly limited. Specific examples of the aromatic ring include a benzene ring and a naphthalene ring.

For example, polyethylene terephthalate (PET) is a polyester containing a benzene ring, and is a resin obtained by polycondensing ethylene glycol with terephthalic acid and/or dimethyl terephthalate. The “polyethylene terephthalate” in the present invention and the present specification includes those having a structure having one or more other components (for example, a copolymer component, a component introduced into a terminal or a side chain, or the like) in addition to the above component.

Polyethylene naphthalate (PEN) is a polyester containing a naphthalene ring, and is a resin obtained by performing an esterification reaction between dimethyl 2,6-naphthalenedicarboxylate and ethylene glycol and then performing a transesterification reaction and a polycondensation reaction. The term “polyethylene naphthalate” in the present invention and the present specification includes those having a structure having one or more other components (for example, a copolymer component, a component introduced into a terminal or a side chain, or the like) in addition to the above component.

In addition, in one aspect, the non-magnetic support of the magnetic tape can be an aromatic polyamide support. In the present invention and the present specification, the term “aromatic polyamide” means a resin including an aromatic skeleton and a plurality of amide bonds. An aromatic ring contained in the aromatic skeleton of the aromatic polyamide is not particularly limited. Specific examples of the aromatic ring include a benzene ring. The term “aromatic polyamide support” means a support including at least one layer of aromatic polyamide film. The term “aromatic polyamide film” refers to a film in which a component that accounts for the largest amount on a mass basis among components constituting the film is an aromatic polyamide. The term “aromatic polyamide support” in the present invention and the present specification includes those in which all resin films contained in the support are aromatic polyamide films, and those containing the aromatic polyamide film and another resin film. Specific examples of the aromatic polyamide support include a single aromatic polyamide film, a laminated film of two or more layers of the aromatic polyamide film having the same constituent component, a laminated film of two or more layers of the aromatic polyamide film having different constituent components, and a laminated film including one or more layers of the aromatic polyamide film and one or more layers of resin film other than the aromatic polyamide. An adhesive layer or the like may be optionally included between two adjacent layers in the laminated film. The aromatic polyamide support may optionally include a metal film and/or a metal oxide film formed on one or both surfaces by vapor deposition or the like.

In addition, as described above, the non-magnetic support may be a biaxially stretched film, and may be a film that has been subjected to corona discharge, a plasma treatment, an easy-bonding treatment, a heat treatment, or the like.

As an index of the physical properties of the non-magnetic support, for example, a moisture content can be used. In the present invention and the present specification, a moisture content of the non-magnetic support is a value obtained by the following method.

A sample piece (for example, a sample piece having a mass of a few grams) cut out from the non-magnetic support of which the moisture content is to be measured is dried in a vacuum dryer at a temperature of 180° C. and a pressure of 100 Pascal (Pa) or less until the sample piece has a constant weight. A mass of the sample piece thus dried is defined as W1. W1 is a value measured in a measurement environment of a temperature of 23° C. and a relative humidity of 50% within 30 seconds after the sample piece is taken out from the vacuum dryer. Next, a mass of this sample piece after being left under an environment of a temperature of 25° C. and a relative humidity of 75% for 48 hours is defined as W2. W2 is a value measured in a measurement environment of a temperature of 23° C. and a relative humidity of 50% within 30 seconds after the sample piece is taken out from the environment. The moisture content is calculated by the following equation.

$$Moisture content ( \% ) = [ ( W 2 - W 1 ) / W 1 ] \times 100$$

For example, after removing portions, such as the magnetic layer, other than the non-magnetic support from the magnetic tape by a well-known method (for example, film removal using an organic solvent), the moisture content of the non-magnetic support can be obtained by the above method.

In one aspect, the above-described non-magnetic support of the magnetic tape preferably has a moisture content of 2.0% or less, more preferably 1.8% or less, still more preferably 1.6% or less, even more preferably 1.4% or less, further preferably 1.2% or less, and still further more preferably 1.0% or less. In addition, the moisture content of the non-magnetic support of the magnetic tape may be 0%, 0% or more, more than 0%, or 0.1% or more.

Examples of an index of physical properties of the non-magnetic support also include a young's modulus. In the present invention and the present specification, the young's modulus of the non-magnetic support is a value to be measured by the following method in a measurement environment with a temperature of 23° C. and a relative humidity of 50%.

A sample piece cut out from the non-magnetic support to be measured is pulled by a universal tensile test device under the conditions of a distance between chucks of 100 mm, a tensile speed of 10 mm/min, and a chart speed of 500 mm/min. As the universal tensile test device, for example, a commercially available universal tensile test device such as Tensilon manufactured by Toyo Baldwin Co., Ltd. or a universal tensile test device having a known configuration can be used. Young's moduli in a longitudinal direction and a width direction of the sample piece are calculated from a tangent line of a rising portion of a load-elongation curve thus obtained. Here, the longitudinal direction and the width direction of the sample piece mean a longitudinal direction and a width direction in a case where the sample piece is included in the magnetic tape.

For example, after removing portions, such as the magnetic layer, other than the non-magnetic support from the magnetic tape by a well-known method (for example, film removal using an organic solvent), the young's moduli in the longitudinal direction and the width direction of the non-magnetic support can be obtained by the above method.

In one aspect, the young's modulus of the non-magnetic support of the magnetic tape in the longitudinal direction is preferably 3000 MPa or more, more preferably 4000 MPa or more, still more preferably 5000 MPa or more, and still more preferably 6000 MPa or more. In addition, the young's modulus of the non-magnetic support of the magnetic tape in the longitudinal direction may be 15000 MPa or less, 13000 MPa or less, or 12000 MPa or less. Regarding the width direction, the young's modulus of the non-magnetic support of the magnetic tape in the width direction is preferably 2000 MPa or more, more preferably 3000 MPa or more, still more preferably 4000 MPa or more, and still more preferably 5000 MPa or more. In addition, the young's modulus of the non-magnetic support of the magnetic tape in the width direction may be 12000 MPa or less, 11000 MPa or less, or 10000 MPa or less. In a case where the magnetic tape is manufactured, the non-magnetic support is usually used in a machine direction (MD direction) as the longitudinal direction and a transverse direction (TD direction) as the width direction of the film. Further, in one aspect, the young's modulus in the longitudinal direction is preferably larger than the young's modulus in the width direction, and a difference (the young's modulus in the longitudinal direction—the young's modulus in the width direction) is more preferably in the range of 800 MPa to 3000 MPa.

The moisture content and the young's modulus of the non-magnetic support can be controlled by the types and mixing ratios of the components constituting the support, the manufacturing conditions of the support, and the like. For example, the young's modulus in the longitudinal direction and the young's modulus in the width direction can be controlled respectively by adjusting a stretching ratio in each direction in a biaxial stretching treatment.

### Back Coating Layer

The magnetic tape may or may not have a back coating layer including a non-magnetic powder on a surface side of the non-magnetic support opposite to a surface side having the magnetic layer. The back coating layer preferably contains one or both of carbon black and an inorganic powder. The back coating layer can include a binding agent, and can also include an additive. For details of the non-magnetic powder, the binding agent, and the additive of the back coating layer, a well-known technology regarding the back coating layer can be applied, and a well-known technology regarding the magnetic layer and/or the non-magnetic layer can be applied. For example, for the back coating layer, descriptions disclosed in paragraphs 0018 to 0020 of JP2006-331625A and page 4, line 65, to page 5, line 38, of U.S. Pat. No. 7,029,774B can be referred to.

### Various Thicknesses

Regarding a thickness (total thickness) of the magnetic tape, it has been required to increase the recording capacity (increase the capacity) of the magnetic tape with the enormous increase in the amount of information in recent years. For example, as means for increasing the capacity, a thickness of the magnetic tape may be reduced to increase a length of the magnetic tape accommodated in one roll of a magnetic tape cartridge. From this point, the thickness (total thickness) of the magnetic tape is preferably 5.6 μm or less, more preferably 5.5 μm or less, even more preferably 5.4 μm or less, still preferably 5.3 μm or less, still more preferably 5.2 μm or less, still even more preferably 5.0 μm or less. In addition, from the viewpoint of ease of handling, the thickness of the magnetic tape is preferably 3.0 μm or more, and more preferably 3.5 μm or more.

The thickness (total thickness) of the magnetic tape can be measured by the following method.

Ten tape samples (for example, 5 to 10 cm in length) are cut out from any part of the magnetic tape, and these tape samples are stacked to measure the thickness. A value (thickness per tape sample) obtained by dividing the measured thickness by 1/10 is defined as the tape thickness. The thickness measurement can be performed using a well-known measuring instrument capable of measuring a thickness on the order of 0.1 μm.

A thickness of the non-magnetic support is preferably 2.0 to 5.0 μm, and more preferably 3.0 to 5.0 μm.

A thickness of the magnetic layer can be optimized according to a saturation magnetization amount of a magnetic head used, a head gap length, a band of a recording signal, and the like, and is generally 0.01 μm to 0.15 μm, and, from the viewpoint of high-density recording, the thickness is preferably 0.02 μm to 0.12 μm and more preferably 0.03 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, preferably 0.1 to 1.0 μm, and more preferably 0.1 to 0.7 μm.

A thickness of the back coating layer is preferably 0.9 μm or less and more preferably 0.1 to 0.7 μm.

Various thicknesses such as the thickness of the magnetic layer and the like can be obtained by the following method.

A cross section of the magnetic tape in a thickness direction is exposed by an ion beam, and then the exposed cross section is subjected to cross-sectional observation using a scanning electron microscope or a transmission electron microscope. Various thicknesses can be obtained as an arithmetic average of thicknesses obtained at two optional points in the cross-sectional observation. Alternatively, the various thicknesses can be obtained as a designed thickness calculated according to manufacturing conditions.

### Manufacturing Method

### Preparation of Composition for Forming Each Layer

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of composition for forming each layer may be added at an initial stage or in a middle stage of each step. As a solvent, one kind or two or more kinds of various solvents usually used for manufacturing a coating type magnetic recording medium can be used. For the solvent, descriptions disclosed in paragraph 0153 of JP2011-216149A can be referred to, for example. In addition, each component may be separately added in two or more steps. For example, a binding agent may be added separately in a kneading step, a dispersing step, and a mixing step for adjusting a viscosity after dispersion.

In order to manufacture the magnetic tape, a conventionally well-known manufacturing technology can be used in various steps. In the kneading step, an open kneader, a continuous kneader, a pressure kneader, or a kneader having a strong kneading force such as an extruder is preferably used. For details of these kneading treatments, JP1989-106338A (JP-H01-106338A) and JP1989-79274A (JP-H01-79274A) can be referred to. As a disperser, a well-known disperser can be used. In any stage of preparing the composition for forming each layer, filtering may be performed by a known method. The filtering can be performed by using a filter, for example. As the filter used in the filtering, a filter having a pore diameter of 0.01 to 3 μm (for example, a filter made of glass fiber or a filter made of polypropylene) can be used, for example.

The ferromagnetic powder and the protrusion forming agent can also be simultaneously dispersed. More specifically, the “simultaneous dispersion” is a method of preparing a composition for forming a magnetic layer by adding a protrusion forming agent liquid (however, not substantially including a ferromagnetic powder) including a protrusion forming agent and a solvent in a stage of mixing various components for preparing a magnetic liquid, such as a ferromagnetic powder, a solvent, and a binding agent. The expression of “substantially not including a ferromagnetic powder” means that the ferromagnetic powder is not added as a constituent component of the protrusion forming agent liquid, and a small amount of the ferromagnetic powder present as impurities by being mixed without intention is allowed.

On the other hand, the ferromagnetic powder and the protrusion forming agent can also be separately dispersed. More specifically, the “separate dispersion” is a method of preparing a composition for forming a magnetic layer by adding a protrusion forming agent liquid (however, not substantially including a ferromagnetic powder) including a protrusion forming agent and a solvent to a magnetic liquid prepared by mixing magnetic liquid components such as a ferromagnetic powder, a solvent, and a binding agent.

The present inventor supposes that, by carrying out the simultaneous dispersion, the aggregation of the protrusion forming agent in the magnetic layer is easily suppressed as compared with a case of carrying out the separate dispersion, and as a result, the value of the rate of change in protrusion area ratio is easily decreased.

In addition, it is supposed that, as the dispersion time in the step of preparing the composition for forming a non-magnetic layer is longer, a denser non-magnetic layer can be formed, and thus the sinking of the protrusion forming agent into the magnetic layer due to the reciprocating slide can be suppressed. It is considered that this contributes to reducing the value of the rate of change in protrusion area ratio.

### Coating Step

The magnetic layer can be formed, for example, by directly applying the composition for forming a magnetic layer onto the non-magnetic support or performing multilayer applying of the composition for forming a magnetic layer with the composition for forming a non-magnetic layer sequentially or simultaneously. In a case of performing an alignment treatment, the alignment treatment is performed on a coating layer of the composition for forming a magnetic layer in an alignment zone while the coating layer is in a wet state. For the alignment treatment, various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone.

The back coating layer can be formed by applying a composition for forming a back coating layer onto a side of the non-magnetic support opposite to a side having the magnetic layer (or to be provided with the magnetic layer).

The coating step for forming each layer can also be performed in two or more stages of steps. For example, in one aspect, the composition for forming a magnetic layer can be applied in two or more stages of steps. In this case, a drying treatment may be performed or need not be performed between the two-stage coating steps. In addition, the alignment treatment may be performed or need not be performed between the two-stage coating steps.

For details of the coating for forming each layer, a description disclosed in a paragraph 0066 of JP2010-231843A can be referred to. In addition, a well-known technology can be applied to the drying step after the application of the composition for forming each layer.

### Other Steps

After the above-described coating step, a calendering treatment is usually performed in order to improve the surface smoothness of the magnetic tape. It is supposed that, by strengthening the calendering conditions, a denser non-magnetic layer can be formed, and thus the sinking of the protrusion forming agent into the magnetic layer due to the reciprocating slide can be suppressed. It is considered that this contributes to reducing the value of the rate of change in protrusion area ratio. Examples of strengthening the calendering conditions include increasing a calender pressure, increasing a calender temperature, decreasing a calender speed, and increasing the number of times of calender. For calendering conditions, a calender pressure is, for example, 200 to 500 kN/m, preferably 250 to 350 kN/m, a calender temperature is preferably 90° C. to 120° C. and more preferably 100° C. to 120° C., and a calender speed is, for example, 50 to 300 m/min, and preferably 80 to 200 m/min. The number of times of calender is preferably 2 or more, and may be, for example, 2 to 4.

For other various steps for manufacturing the magnetic tape, descriptions disclosed in paragraphs 0067 to 0070 of JP2010-231843A can be referred to.

Through various steps, a long magnetic tape original roll can be obtained. The obtained magnetic tape original roll is cut (slit) by a well-known cutter, for example, to have a width of the magnetic tape to be accommodated in the magnetic tape cartridge. The width can be determined according to the standard, and is usually ½ inches.

A servo pattern is usually formed on the magnetic tape obtained by slitting.

### Formation of Servo Pattern

The term “formation of servo pattern” can also be referred to as “recording of servo signal”. The formation of the servo pattern will be described below.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) standard (generally called “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

In a method of uniquely specifying the servo band, a staggered method as shown in ECMA-319 (June 2001) is used. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps can be transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape. Vertical squareness ratio

In one aspect, the vertical squareness ratio of the magnetic tape, may be, for example, 0.55 or more, and from the viewpoint of improving the electromagnetic conversion characteristics, the vertical squareness ratio is preferably 0.60 or more, and more preferably 0.65 or more. In principle, the upper limit of the squareness ratio is 1.00 or less. The vertical squareness ratio of the magnetic tape may be 1.00 or less, 0.95 or less, 0.90 or less, 0.85 or less, or 0.80 or less. From the viewpoint of improving the electromagnetic conversion characteristics, a large value of the vertical squareness ratio of the magnetic tape is preferable. The vertical squareness ratio of the magnetic tape can be controlled by a well-known method such as performing a vertical alignment treatment.

In the present invention and the present specification, the term “vertical squareness ratio” refers to a squareness ratio measured in the vertical direction of the magnetic tape. The term “vertical direction” described regarding the squareness ratio refers to a direction orthogonal to the magnetic layer surface, and can also be referred to as a thickness direction. In the present invention and the present specification, the vertical squareness ratio is obtained by the following method.

A sample piece having a size capable of being introduced into a vibrating sample magnetometer is cut out from the magnetic tape to be measured. For this sample piece, using a vibrating sample magnetometer, a magnetic field is applied in the vertical direction (direction orthogonal to the magnetic layer surface) of the sample piece at a maximum applied magnetic field of 3979 kA/m, a measurement temperature of 296 K, and a magnetic field sweeping speed of 8.3 kA/m/sec, and the magnetization strength of the sample piece with respect to the applied magnetic field is measured. The measured value of the magnetization strength is obtained as a value after demagnetic field correction and as a value obtained by subtracting the magnetization of a sample probe of the vibrating sample magnetometer as a background noise. Assuming that the magnetization strength at the maximum applied magnetic field is Ms and the magnetization strength at zero applied magnetic field is Mr, a squareness ratio SQ is a value calculated as SQ=Mr/Ms. The measurement temperature refers to a temperature of the sample piece, and, by setting an atmosphere temperature around the sample piece to a measurement temperature, the temperature of the sample piece can be set to a measurement temperature by establishing a temperature equilibrium.

### Magnetic Tape Cartridge

Another aspect of the present invention relates to a magnetic tape cartridge comprising the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic tape apparatus for recording and/or reproducing data on the magnetic tape, the magnetic tape is pulled out of the magnetic tape cartridge to be wound around the reel on the magnetic tape apparatus side. A magnetic head is arranged on a magnetic tape transportation path from the magnetic tape cartridge to a winding reel. Feeding and winding of the magnetic tape are performed between a reel (supply reel) on the magnetic tape cartridge side and a reel (winding reel) on the magnetic tape apparatus side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge.

In one aspect, the magnetic tape cartridge may include a cartridge memory. The cartridge memory can be, for example, a non-volatile memory, and head tilt angle adjustment information is already recorded or the head tilt angle adjustment information is recorded. The head tilt angle adjustment information is information for adjusting the head tilt angle during running of the magnetic tape in the magnetic tape apparatus. For example, as the head tilt angle adjustment information, the value of the servo band interval at each position in the longitudinal direction of the magnetic tape during data recording can be recorded. For example, in a case of reproducing the data recorded on the magnetic tape, the value of the servo band interval can be measured during reproduction, and the head tilt angle can be changed by a control device of the magnetic tape apparatus such that the absolute value of the difference from the servo band interval during recording at the same longitudinal position recorded in the cartridge memory approaches zero. The head tilt angle may be, for example, the angle θ described above. In a case where the data is recorded and/or reproduced by tilting the head, the angle θ described above can be more than 0°, 45° or less, 40° or less, or 35° or less.

The magnetic tape and the magnetic tape cartridge can be suitably used in a magnetic tape apparatus (in other words, a magnetic recording and reproducing system) that records and/or reproduces data by changing the head tilt angle during running of the magnetic tape. In such a use form, since a period in which the head is tilted is included during recording and/or reproduction of data, a magnetic tape having high running stability in a case where data is recorded and/or reproduced by tilting the head is preferable.

However, the magnetic tape and the magnetic tape cartridge are not limited to those used in such a magnetic tape apparatus. There is also a use form, for example, in which the head tilt angle in one recording or reproduction and the head tilt angle in subsequent recording or reproduction are changed, and then the head tilt angle is fixed without changing the head tilt angle during each recording or during each reproduction. Even in such a use form, since a period of tilting the head is included during recording and/or reproduction of data, a magnetic tape having high running stability in a case of recording and/or reproducing data by tilting the head is preferable.

### Magnetic Tape Apparatus

Still another aspect of the present invention relates to a magnetic tape apparatus including the magnetic tape described above. In the magnetic tape apparatus, recording of data on the magnetic tape and/or reproduction of data recorded on the magnetic tape can be performed, for example, as the magnetic layer surface of the magnetic tape and the magnetic head come into contact with each other to be slid on each other. The magnetic tape apparatus can attachably and detachably include the magnetic tape cartridge according to one aspect of the present invention.

The magnetic tape cartridge can be mounted on the magnetic tape apparatus comprising the magnetic head and used for recording and/or reproducing data. In the present invention and the present specification, the term “magnetic tape apparatus” means an apparatus capable of performing at least one of the recording of data on the magnetic tape or the reproduction of data recorded on the magnetic tape. Such an apparatus is generally called a drive.

### Magnetic Head

The magnetic tape apparatus may include a magnetic head. The configuration of the magnetic head and the angle θ, which is the head tilt angle, are as described above with reference to FIGS. 1 to 3. The magnetic head included in the magnetic tape apparatus can be an LTO 8 head in one aspect, can be an LTO head of another generation in another aspect, and can be a magnetic head other than the LTO head in another aspect. In a case where the magnetic head includes a reproducing element, a magnetoresistive (MR) element capable of sensitively reading information recorded on the magnetic tape is preferable as the reproducing element. As the MR element, various well-known MR elements (for example, a giant magnetoresistive (GMR) element and a tunnel magnetoresistive (TMR) element) can be used. Hereinafter, a magnetic head that records data and/or reproduces recorded data will also be referred to as a “recording and reproducing head”. An element for recording data (recording element) and an element for reproducing data (reproducing element) are collectively referred to as a “magnetic head element”.

In a case of recording data and/or reproducing recorded data, first, tracking using the servo signal can be performed. That is, by causing the servo signal reading element to follow a predetermined servo track, the magnetic head element can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

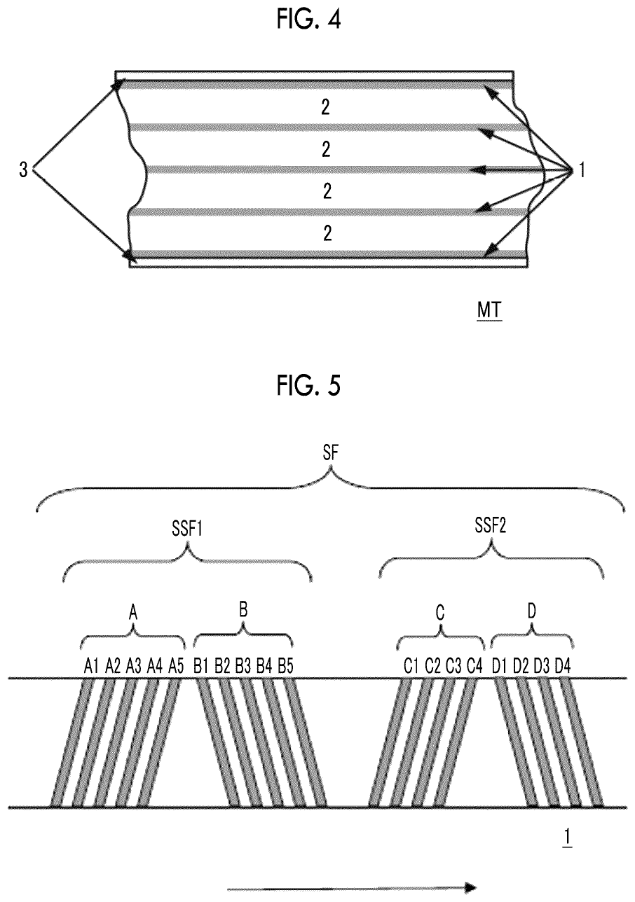

FIG. 4 shows an arrangement example of data bands and servo bands. In FIG. 4, a plurality of servo bands 1 are arranged to be interposed between guide bands 3 in a magnetic layer of a magnetic tape MT. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 5 are formed on a servo band, in a case of manufacturing a magnetic tape. Specifically, in FIG. 5, a servo frame SF on the servo band 1 is composed of a servo sub-frame 1 (SSF1) and a servo sub-frame 2 (SSF2). The servo sub-frame 1 is composed of an A burst (in FIG. 5, reference sign A) and a B burst (in FIG. 5, reference sign B). The A burst is composed of servo patterns A1 to A5 and the B burst is composed of servo patterns B1 to B5. Meanwhile, the servo sub-frame 2 is composed of a C burst (in FIG. 5, reference sign C) and a D burst (in FIG. 5, reference sign D). The C burst is composed of servo patterns C1 to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 5 shows one servo frame for description. Note that, in practice, a plurality of the servo frames are arranged in the running direction in each servo band in the magnetic layer of the magnetic tape on which the head tracking of the timing-based servo system is performed. In FIG. 5, the arrow indicates the running direction of the magnetic tape. For example, an LTO Ultrium format tape usually has 5000 or more servo frames per 1 m of tape length in each servo band of the magnetic layer.

In the magnetic tape apparatus, the head tilt angle can be changed during running of the magnetic tape in the magnetic tape apparatus. The head tilt angle is, for example, an angle θ formed by the axis of the element array with respect to the width direction of the magnetic tape. The angle θ is as described above. For example, by providing the recording and reproducing head unit of the magnetic head with an angle adjustment unit for adjusting the angle of the module of the magnetic head, the angle θ can be variably adjusted during running of the magnetic tape. Such an angle adjustment unit can include, for example, a rotation mechanism for rotating the module. A well-known technology can be applied to the angle adjustment unit.

Regarding the head tilt angle during running of the magnetic tape, in a case where the magnetic head includes a plurality of modules, it is possible to specify the angle θ described with reference to FIGS. 1 to 3 for randomly selected modules. θᵢₙᵢₜᵢₐₗ, which is an angle θ at the start of running of the magnetic tape, can be set to 0° or more or more than 0°. This is preferable in terms of adjustment ability to adjust the effective distance between the servo signal reading elements in response to the dimension change in the width direction of the magnetic tape, because the larger θᵢₙᵢₜᵢₐₗ, the larger the amount of change in the effective distance between the servo signal reading elements with respect to the amount of change in the angle θ. From this point, θᵢₙᵢₜᵢₐₗ is preferably 1° or more, more preferably 5° or more, and still more preferably 10° or more. On the other hand, for an angle (generally referred to as “wrap angle”) formed between the magnetic layer surface and the contact surface of the magnetic head in a case where the magnetic tape runs and comes into contact with the magnetic head, it is effective to keep the deviation with respect to the tape width direction small in order to improve the uniformity in the tape width direction of the friction generated by the contact between the magnetic head and the magnetic tape during running of the magnetic tape. In addition, it is desirable to increase the uniformity of the friction in the tape width direction from the viewpoint of the position followability and the running stability of the magnetic head. From the viewpoint of reducing the deviation of the wrap angle in the tape width direction, θᵢₙᵢₜᵢₐₗ is preferably 45° or less, more preferably 40° or less, and still more preferably 35° or less.

Regarding the change in angle θ during running of the magnetic tape, in a case where the angle θ of the magnetic head changes from θᵢₙᵢₜᵢₐₗ at the start of running while the magnetic tape runs in the magnetic tape apparatus for the recording of data on the magnetic tape and/or for the reproduction of data recorded on the magnetic tape, the maximum change amount Δθ of the angle θ during the running of the magnetic tape is the larger value between Δθₘₐₓ and Δθₘᵢₙ calculated by the following equation. The maximum value of the angle θ during running of the magnetic tape is θₘₐₓ, and the minimum value is θₘᵢₙ. Note that “max” is an abbreviation for maximum, and “min” is an abbreviation for minimum.

$$Δ {θ}_{max} = {θ}_{max} - {θ}_{initial}$$

$$Δ {θ}_{min} = {θ}_{initial} - {θ}_{min}$$

In one aspect, Δθ may be more than 0.000°, and, from the viewpoint of the adjustment ability to adjust the effective distance between the servo signal reading elements in response to the dimension change in the width direction of the magnetic tape, Δθ is preferably 0.001° or more and more preferably 0.010° or more. From the viewpoint of easiness of ensuring synchronization of the recorded data and/or the reproduced data between a plurality of magnetic head elements during the recording and/or reproduction of the data, Δθ is preferably 1.000° or less, more preferably 0.900° or less, still more preferably 0.800° or less, still more preferably 0.700° or less, and still more preferably 0.600° or less.

In the example shown in FIG. 2 and FIG. 3, the axis of the element array is tilted in the running direction of the magnetic tape. Note that the present invention is not limited to such an example. In the above-described magnetic tape apparatus, an embodiment in which the axis of the element array is tilted in a direction opposite to the running direction of the magnetic tape is also included in the present invention.

θᵢₙᵢₜᵢₐₗ, which is the head tilt angle at the start of running of the magnetic tape, can be set by a control device of the magnetic tape apparatus or the like.

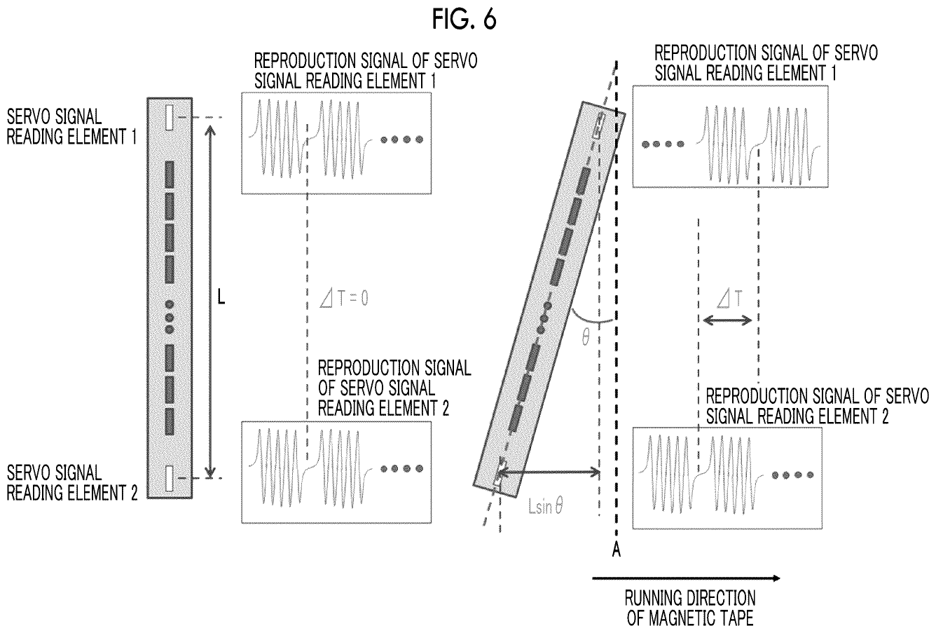

Regarding the head tilt angle during running of the magnetic tape, FIG. 6 is an explanatory diagram of a measuring method of the angle θ during running of the magnetic tape. The angle θ during running of the magnetic tape can be obtained, for example, by the following method. In a case where the angle θ during running of the magnetic tape is obtained by the following method, the angle θ is changed in a range of 0° to 90° during running of the magnetic tape. That is, in a case where the axis of the element array is tilted in the running direction of the magnetic tape at the start of running of the magnetic tape, the element array is not tilted such that the axis of the element array is tilted in the direction opposite to the running direction of the magnetic tape at the start of running of the magnetic tape, during running of magnetic tape, and in a case where the axis of the element array is tilted in the direction opposite to the running direction of the magnetic tape at the start of running of the magnetic tape, the element array is not tilted such that the axis of the element array is tilted in the running direction of the magnetic tape at the start of running of the magnetic tape, during running of the magnetic tape.

A phase difference (that is, a time difference) AT between the reproduction signals of the pair of servo signal reading elements 1 and 2 is measured. The measurement of ΔT can be performed by a measurement unit provided in the magnetic tape apparatus. A configuration of such a measurement unit is well-known. The distance L between the central portion of the servo signal reading element 1 and the central portion of the servo signal reading element 2 can be measured by an optical microscope or the like. In a case where the running speed of the magnetic tape is a speed v, the distance between the central portions of the two servo signal reading elements in the running direction of the magnetic tape is L sin θ, and a relationship of L sin θ=v×ΔT is established. Therefore, the angle θ during running of the magnetic tape can be calculated by the equation “θ=arcsin (vΔT/L)”. The right figure of FIG. 6 shows an example in which the axis of the element array is tilted in the running direction of the magnetic tape. In this example, the phase difference (that is, the time difference) ΔT of the phase of the reproduction signal of the servo signal reading element 2 with respect to the phase of the reproduction signal of the servo signal reading element 1 is measured. In a case where the axis of the element array is tilted in the direction opposite to the running direction of the magnetic tape, θ can be obtained by the above-described method except for a point where ΔT is measured as the phase difference (that is, the time difference) of the phase of the reproduction signal of the servo signal reading element 1 with respect to the phase of the reproduction signal of the servo signal reading element 2.

A pitch suitable for a measurement pitch of the angle θ, that is, a measurement interval of the angle θ in the tape longitudinal direction can be selected according to a frequency of the tape width deformation in the tape longitudinal direction. As an example, the measurement pitch can be set to, for example, 250 μm.

### Configuration of Magnetic Tape Apparatus

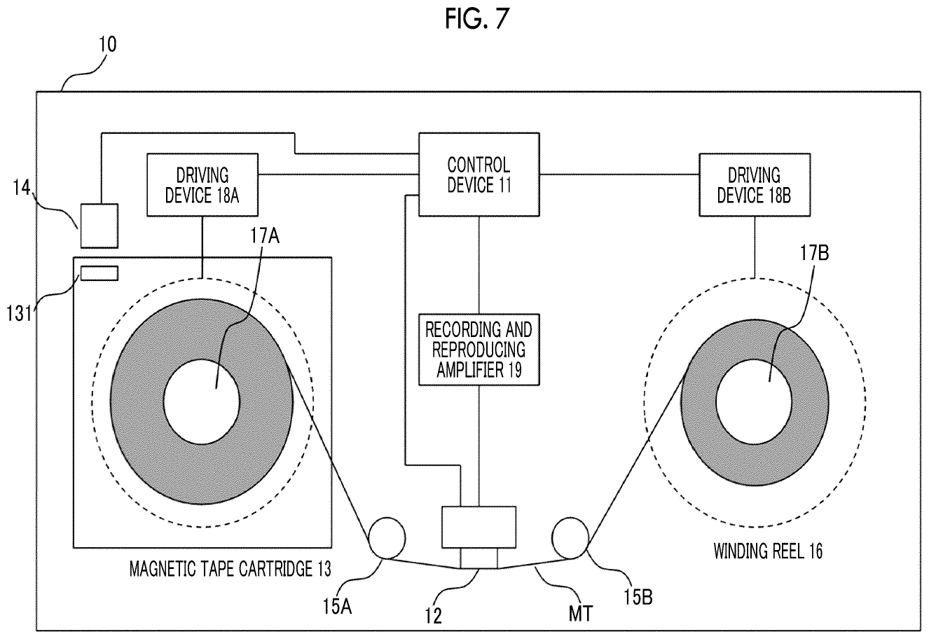

A magnetic tape apparatus 10 shown in FIG. 7 controls a recording and reproducing head unit 12 in accordance with an instruction from a control device 11, and records and reproduces data on a magnetic tape MT.

The magnetic tape apparatus 10 has a configuration capable of detecting and adjusting the tension applied in the longitudinal direction of the magnetic tape from spindle motors 17A and 17B for controlling rotation of a magnetic tape cartridge reel and a winding reel and driving devices 18A and 18B thereof.

The magnetic tape apparatus 10 has a configuration capable of loading a magnetic tape cartridge 13.

The magnetic tape apparatus 10 has a cartridge memory reading and writing device 14 capable of reading and writing a cartridge memory 131 in the magnetic tape cartridge 13.

From the magnetic tape cartridge 13 mounted on the magnetic tape apparatus 10, an end part or a leader pin of the magnetic tape MT is pulled out by an automatic loading mechanism or a manual operation, and the magnetic layer surface of the magnetic tape MT passes on the recording and reproducing head through guide rollers 15A and 15B in a direction contacting with a recording and reproducing head surface of the recording and reproducing head unit 12, and thus the magnetic tape MT is wound around a winding reel 16.

The rotation and torque of the spindle motor 17A and the spindle motor 17B are controlled by a signal from the control device 11, and the magnetic tape MT is run at any speed and tension. A servo pattern formed in advance on the magnetic tape can be used for a control of the tape speed and a control of the head tilt angle. In order to detect the tension, a tension detecting mechanism may be provided between the magnetic tape cartridge 13 and the winding reel 16. The tension may be controlled by using the guide rollers 15A and 15B in addition to the control by the spindle motors 17A and 17B.

The cartridge memory reading and writing device 14 is configured to be capable of reading out and writing information in the cartridge memory 131 in response to an instruction from the control device 11. As a communication method between the cartridge memory reading and writing device 14 and the cartridge memory 131, for example, an international organization for standardization (ISO) 14443 method can be employed.

The control device 11 includes, for example, a controller, a storage unit, a communication unit, and the like.

The recording and reproducing head unit 12 includes, for example, a recording and reproducing head, a servo tracking actuator that adjusts a position of the recording and reproducing head in the track width direction, a recording and reproducing amplifier 19, a connector cable for connection with the control device 11, and the like. The recording and reproducing head includes, for example, a recording element for recording data on the magnetic tape, a reproducing element for reproducing data on the magnetic tape, and a servo signal reading element for reading a servo signal recorded on the magnetic tape. For example, one or more recording elements, reproducing elements, and servo signal reading elements are mounted in one magnetic head. Alternatively, each element may be separately provided in a plurality of magnetic heads according to the running direction of the magnetic tape.

The recording and reproducing head unit 12 is configured to be capable of recording data on the magnetic tape MT in response to an instruction from the control device 11. In addition, the recording and reproducing head unit 12 is configured to be capable of reproducing the data recorded on the magnetic tape MT in response to an instruction from the control device 11.

The control device 11 has a mechanism for obtaining the running position of the magnetic tape from the servo signal read from the servo band in a case where the magnetic tape MT is run, and controlling the servo tracking actuator such that the recording element and/or the reproducing element is located at a target running position (track position). The track position is controlled by feedback control, for example. The control device 11 has a mechanism for obtaining a servo band interval from servo signals read from two adjacent servo bands in a case where the magnetic tape MT is run. The control device 11 can store the obtained information on the servo band interval in the storage unit inside the control device 11, the cartridge memory 131, an external connection device, or the like. In addition, the control device 11 can change the head tilt angle according to the dimension information in the width direction of the magnetic tape during running. Accordingly, the effective distance between the servo signal reading elements can be made to approximate to or match with the interval between the servo bands. The dimension information can be acquired by using a servo pattern formed in advance on the magnetic tape. For example, in this way, during running of the magnetic tape in the magnetic tape apparatus, the angle θ formed by the axis of the element array with respect to the width direction of the magnetic tape can be changed according to the dimension information in the width direction of the magnetic tape acquired during running. The head tilt angle can be adjusted, for example, by feedback control. For example, the adjustment of the head tilt angle can also be performed by the method disclosed in JP2016-524774A or US2019/0164573A1.

### EXAMPLES

Hereinafter, the present invention will be described based on Examples. Note that the present invention is not limited to the embodiments shown in Examples. The term “part” described below indicates “part by mass”. The steps and evaluations in the following description were performed in an environment of a temperature of 23° C.±1° C., unless otherwise noted. “eq” in the following description is an equivalent and is a unit that cannot be converted into an SI unit.

### Protrusion Forming Agent

A protrusion forming agent used in preparation of a composition for forming a magnetic layer for manufacturing magnetic tapes of Examples or Comparative Examples is as follows.
Protrusion forming agent A: Asahi #50 (carbon black) manufactured by Asahi Carbon Co., Ltd., average particle size of 60 nm, and see Table 1 for Mohs hardness
Protrusion forming agent B: colloidal silica manufactured by FUSO CHEMICAL CO., LTD., average particle size of 90 nm, and see Table 1 for Mohs hardness
Protrusion forming agent C: colloidal silica TPX-5200 manufactured by Cabot Corporation, average particle size of 60 nm, and see Table 1 for Mohs hardness

### Fatty Acid Ester

A fatty acid ester used in preparation of a composition for forming a magnetic layer and a composition for forming a non-magnetic layer for manufacturing magnetic tapes of Examples or Comparative Examples is as follows.
Fatty acid ester a: see (secondary) butyl stearate
Fatty acid ester b: butyl palmitate

### Ferromagnetic Powder

In Table 1, “BaFe” is a hexagonal barium ferrite powder (coercivity Hc: 196 kA/m, average particle size (average plate diameter) of 24 nm).

“SrFe1” shown in Table 1 is a hexagonal strontium ferrite powder manufactured by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to a glass bottle containing the product, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10⁵ J/m³, and a mass magnetization σs was 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined. Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

### PANalytical X'Pert Pro Diffractometer, PIXcel Detector

Soller slit of incident beam and diffracted beam: 0.017 radians
Fixed angle of dispersion slit: ¼ degrees
Mask: 10 mm
Anti-scattering slit: ¼ degrees
Measurement mode: continuous
Measurement time per stage: 3 seconds
Measurement speed: 0.017 degrees per second
Measurement step: 0.05 degrees

“SrFe2” shown in Table 1 is a hexagonal strontium ferrite powder manufactured by the following method.

1725 g of SrCO₃, 666 g of H₃BO₃, 1332 g of Fe₂O₃, 52 g of Al(OH)₃, 34 g of CaCO₃, and 141 g of BaCO₃ were weighed and mixed by a mixer to obtain a raw material mixture.

The obtained raw material mixture was melted in a platinum crucible at a melting temperature of 1380° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the obtained amorphous body was charged into an electric furnace, was heated to 645° C. (crystallization temperature), and was held at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to a glass bottle containing the product, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

An average particle size of the obtained hexagonal strontium ferrite powder was 19 nm, an activation volume was 1102 nm³, an anisotropy constant Ku was 2.0×10⁵ J/m³, and a mass magnetization σs was 50 A·m²/kg.

In Table 1, “ε-iron oxide” is an ε-iron oxide powder manufactured by the following method.

8.3 g of iron (III) nitrate nonahydrate, 1.3 g of gallium (III) nitrate octahydrate, 190 mg of cobalt (II) nitrate hexahydrate, 150 mg of titanium (IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at an in-furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was added dropwise and was stirred for 24 hours. A powder sedimented by adding 50 g of ammonium sulfate to the obtained reaction solution was collected by centrifugal separation, was washed with pure water, and was dried in a heating furnace at an in-furnace temperature of 80° C. for 24 hours to obtain a ferromagnetic powder precursor.

The obtained ferromagnetic powder precursor was loaded into a heating furnace at an in-furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ¿-iron oxide (ε-Ga_{0.28}Co_{0.05}Ti_{0.05}Fe_{1.62}O₃). In addition, X-ray diffraction analysis was performed under the same condition as that described above for SrFe1, and from a peak of an X-ray diffraction pattern, it was confirmed that the obtained ferromagnetic powder does not include α-phase and γ-phase crystal structures, and has a single-phase and ε-phase crystal structure (ε-iron oxide crystal structure).

The obtained ε-iron oxide powder had an average particle size of 12 nm, an activation volume of 746 nm³, an anisotropy constant Ku of 1.2×10⁵ J/m³, and a mass magnetization σs of 16 A·m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization σs is a value measured at a magnetic field intensity of 15 kOe using a vibrating sample magnetometer (manufactured by Toei Industry Co., Ltd.).

### Non-Magnetic Support

In Table 1, “PEN” indicates a polyethylene naphthalate support, and “PA” indicates an aromatic polyamide support.

### Example 1

### Composition for Forming Magnetic Layer

### Magnetic Liquid

Ferromagnetic powder (see Table 1): 100.0 parts
Oleic acid: 2.0 parts
Vinyl chloride copolymer (MR-104 manufactured by Kaneka Corporation): 10.0 parts
SO₃Na group-containing polyurethane resin: 4.0 parts
(Weight-average molecular weight: 70000, SO₃Na group: 0.07 meq/g)
Additive A: 10.0 parts
Methyl ethyl ketone: 150.0 parts
Cyclohexanone: 150.0 parts (abrasive solution)
α-Alumina (average particle size: 110 nm): 6.0 parts
Vinyl chloride copolymer (MR110 manufactured by Kaneka Corporation): 0.7 parts
Cyclohexanone: 20.0 parts
Protrusion forming agent liquid
Protrusion forming agent (see Table 1): see Table 1
Methyl ethyl ketone: 6.0 parts
Cyclohexanone: 4.0 parts
Other components
Stearic acid: 1.0 part
Stearic acid amide: 0.3 parts
Fatty acid ester (see Table 1): see Table 1
Methyl ethyl ketone: 110.0 parts
Cyclohexanone: 110.0 parts
Polyisocyanate (CORONATE (registered trademark) L manufactured by Tosoh Corporation): 3.0 parts

The above-described additive A is a polymer synthesized by the method disclosed in paragraphs 0115 to 0123 of JP2016-051493A.

### Composition for Forming Non-Magnetic Layer

Non-magnetic inorganic powder (α-iron oxide): 80.0 parts
(Average particle size: 0.15 μm, average acicular ratio: 7, brunauer-emmett-teller (BET) specific surface area: 52 m²/g)
Carbon black (average particle size: 20 nm): 20.0 parts
Electron beam curable vinyl chloride copolymer: 13.0 parts
Electron beam curable polyurethane resin: 6.0 parts
Phenylphosphonic acid: 3.0 parts
Cyclohexanone: 140.0 parts
Methyl ethyl ketone: 170.0 parts
Fatty acid ester of the same kind as the fatty acid ester added to the composition for forming a magnetic layer: 2.0 parts
Stearic acid: 1.0 part
Composition for forming back coating layer
Non-magnetic inorganic powder (α-iron oxide): 80.0 parts
(Average particle size: 0.15 μm, average acicular ratio: 7, BET specific surface area: 52 m²/g)
Carbon black (average particle size: 20 nm): 20.0 parts
Carbon black (average particle size: 100 nm): 3.0 parts
Vinyl chloride copolymer: 13.0 parts
Sulfonic acid group-containing polyurethane resin: 6.0 parts
Phenylphosphonic acid: 3.0 parts
Cyclohexanone: 140.0 parts
Methyl ethyl ketone: 170.0 parts
Stearic acid: 3.0 parts
Polyisocyanate (CORONATE (registered trademark) L manufactured by Tosoh Corporation): 5.0 parts
Methyl ethyl ketone: 400.0 parts

### Preparation of Composition for Forming Each Layer

A composition for forming a magnetic layer was prepared by the following method.

The components of the magnetic liquid and the components of the protrusion forming agent liquid were kneaded and diluted by an open kneader, and then subjected to a dispersion treatment (simultaneous dispersion) of 12 passes, with a horizontal beads mill dispersing device using zirconia (ZrO₂) beads (hereinafter, referred to as “Zr beads”) having a particle diameter of 0.5 mm, by setting a retention time per pass to 2 minutes at a bead filling rate of 80 vol % and a circumferential speed of a rotor distal end of 10 m/sec, to obtain a dispersion liquid.

The components of the abrasive solution were mixed and then the mixture was put in a vertical sand mill dispersing device together with Zr beads having a particle diameter of 1 mm, and 100×bead volume/(abrasive solution volume+bead volume) was adjusted to be 60%, and sand mill dispersion treatment was performed for 180 minutes. The liquid after the treatment was taken out and subjected to an ultrasonic dispersion filtration treatment using a flow type ultrasonic dispersion filtration device.

The dispersion liquid prepared by the simultaneous dispersion, the abrasive solution, and other components were put into a dissolver stirrer and stirred for 30 minutes at a circumferential speed of 10 m/sec. After that, the treatment of 3 passes was performed at a flow rate of 7.5 kg/min by a flow type ultrasonic dispersing device, and then, a composition for forming a magnetic layer was prepared by filtration using a filter having a pore diameter of 1 μm.

A composition for forming a non-magnetic layer was prepared by the following method.

The components excluding a lubricant (fatty acid ester and stearic acid) were kneaded and diluted by an open kneader, and then subjected to a dispersion treatment for the dispersion time described in Table 1 by a horizontal beads mill dispersing device. After that, the lubricant (fatty acid ester and stearic acid) was added into the obtained dispersion liquid and stirred and mixed by a dissolver stirrer to prepare a composition for forming a non-magnetic layer.

A composition for forming a back coating layer was prepared by the following method.

The components excluding a lubricant (stearic acid), polyisocyanate, and methyl ethyl ketone (400.0 parts) were kneaded and diluted by an open kneader, and then subjected to a dispersion treatment by a horizontal beads mill dispersing device. After that, the lubricant (stearic acid), polyisocyanate, and methyl ethyl ketone (400.0 parts) were added into the obtained dispersion liquid and stirred and mixed by a dissolver stirrer to prepare a composition for forming a back coating layer.

Manufacture of magnetic tape and magnetic tape cartridge

The composition for forming a non-magnetic layer was applied to the biaxially stretched non-magnetic support (type: see Table 1) having a thickness shown in Table 1 so that the thickness after drying was 0.6 μm, and was dried. Then, the composition for forming a non-magnetic layer was irradiated with an electron beam at an acceleration voltage of 125 kV to have an energy of 40 kGy. A composition for forming a magnetic layer was applied thereonto so that the thickness after drying was 0.1 μm, to form a coating layer. The vertical alignment treatment was performed in the alignment zone by applying a magnetic field having a magnetic field intensity of 0.5 T onto the surface of the coating layer of the composition for forming a magnetic layer in the vertical direction while the coating layer is in a wet state, and then the coating layer was dried. Further, the composition for back coating layer forming was coated onto a surface of the support opposite to a surface on which the non-magnetic layer and the magnetic layer were formed such that the thickness after drying is 0.3 μm and was dried.

After that, a calendering treatment was performed the number of times described in Table 1 using a 7-stage calender roll formed of only a metal roll at a calender speed of 80 m/min, a linear pressure of 294 kN/m, and a calender temperature (surface temperature of calender roll) described in Table 1. After that, a heat treatment was performed for 36 hours in an environment of an atmosphere temperature of 70° C. After the heat treatment, slitting was performed to have ½ inches width, and the magnetic layer surface was cleaned with a tape cleaning device in which a non-woven fabric and a razor blade are attached to a device including a feeding and winding device of the slit so as to press the magnetic layer surface. Thereby, a magnetic tape was obtained.

A servo signal was recorded on the magnetic layer of the obtained magnetic tape by a commercially available servo writer to obtain a magnetic tape having a data band, a servo band, and a guide band in an arrangement according to a linear tape-open (LTO) Ultrium format and having a servo pattern (timing-based servo pattern) in an arrangement and a shape according to the LTO Ultrium format on the servo band. The servo pattern thus formed is a servo pattern according to the description in Japanese industrial standards (JIS) X6175: 2006 and Standard ECMA-319 (June 2001). The total number of servo bands is 5, and the total number of data bands is 4.

The magnetic tape (length of 960 m) on which the servo signal is recorded was wound around a reel of a magnetic tape cartridge (LTO Ultrium 8 data cartridge).

In this way, the magnetic tape cartridge in which the magnetic tape was wound on a reel was manufactured.

### Examples 2 to 17 and Comparative Examples 1 to 5

A magnetic tape and a magnetic tape cartridge were obtained by the method described in Example 1, except that the items shown in Table 1 were changed as shown in Table 1.

In Table 1, for Examples in which “Simultaneous dispersion” is described in the column of the mixing type of the protrusion forming agent, the simultaneous dispersion was performed as described in Example 1.

In Table 1, for Comparative Examples in which “Separate dispersion” is described in the column of the mixing type of the protrusion forming agent, the composition for forming a magnetic layer was prepared as follows.

The components of the magnetic liquid were kneaded and diluted by an open kneader, and then subjected to a dispersion treatment of 12 passes, with a horizontal beads mill dispersing device using zirconia (ZrO₂) beads (“Zr beads”) having a particle diameter of 0.5 mm, by setting a retention time per pass to 2 minutes at a bead filling rate of 80 vol % and a circumferential speed of a rotor distal end of 10 m/sec, to obtain a magnetic liquid.

The components of the abrasive solution were mixed and then the mixture was put in a vertical sand mill dispersing device together with Zr beads having a particle diameter of 1 mm, and bead volume/(abrasive solution volume+bead volume) was adjusted to be 60%, and sand mill dispersion treatment was performed for 180 minutes. The liquid after the treatment was taken out and subjected to an ultrasonic dispersion filtration treatment using a flow type ultrasonic dispersion filtration device.

The components of the protrusion forming agent liquid were mixed and then the mixture was subjected to an ultrasonic treatment (dispersion treatment) for 60 minutes at an ultrasonic output of 500 watts per 200 cc by a horn type ultrasonic dispersing device, and the obtained dispersion liquid was filtered using a filter having a pore diameter of 0.5 μm. Thereby, a protrusion forming agent liquid was prepared.

The magnetic liquid, the abrasive solution, the protrusion forming agent liquid, and other components described above were put into a dissolver stirrer and stirred for 30 minutes at a circumferential speed of 10 m/sec. After that, the treatment of 3 passes was performed at a flow rate of 7.5 kg/min by a flow type ultrasonic dispersing device, and then, a composition for forming a magnetic layer was prepared by filtration using a filter having a pore diameter of 1 μm.

In each of Examples and Comparative Examples, four magnetic tape cartridges were manufactured, one for the following evaluation of the running stability and the other three for the following evaluations (1) to (3) of the magnetic tape.

### Evaluation of Running Stability

In an environment of a temperature of 35° C. and a relative humidity of 80%, running stability was evaluated by the following method.

Using each magnetic tape cartridge of Examples and the Comparative Examples, recording and reproduction of data were performed using a magnetic tape apparatus having the configuration shown in FIG. 7. The arrangement order of the modules included in the recording and reproducing head mounted on the recording and reproducing head unit is “recording module-reproducing module-recording module” (total number of modules: 3). The number of magnetic head elements in each module is 32 (Ch0 to Ch31), and the element array is configured by sandwiching these magnetic head elements between the pair of servo signal reading elements.

The recording and reproduction of data and evaluating of the running stability during the reproducing by the following method were executed with the head tilt angle set to 15°. The head tilt angle is an angle θ formed by the axis of the element array of the reproducing module with respect to the width direction of the magnetic tape at the start of running. The angle θ was set by the control device of the magnetic tape apparatus at the start of running of the magnetic tape, and the head tilt angle was fixed during running of the magnetic tape.

The magnetic tape cartridge was set in the magnetic tape apparatus and the magnetic tape was loaded. Next, pseudo random data having a specific data pattern was recorded on the magnetic tape by the recording and reproducing head unit while performing servo tracking. In this case, the tension applied in the tape longitudinal direction was set to a constant value. Simultaneously with the recording of the data, the value of the servo band interval of the tape entire length was measured at every 1 m of the longitudinal position and recorded in the cartridge memory.

Then, the data recorded on the magnetic tape was reproduced by the recording and reproducing head unit while performing servo tracking. In this case, the tension applied in the tape longitudinal direction was set to a constant value.

The running stability was evaluated using, as an index, standard deviation (hereinafter, referred to as “σPES”) of a reading position error signal (PES) in the width direction based on the servo signal obtained by the servo signal reading element during the reproduction.

The PES was obtained by the following method.

In order to obtain the PES, the dimensions of the servo pattern are required. The standards of the dimensions of the servo pattern depend on the generation of LTO. First, an average distance AC between four stripes corresponding to an A burst and a C burst and an azimuth angle α of the servo pattern were measured by using a magnetic force microscope or the like.

An average time between five stripes corresponding to the A burst and the B burst over a length of one LPOS word is defined as a. An average time between four stripes corresponding to the A burst and the C burst over the length of one LPOS word is defined as b. In this case, a value defined by AC×(½−a/b)/(2× tan(α)) represents a reading position error signal (PES) in the width direction based on the servo signal obtained by the servo signal reading element over a length of one LPOS word. For the magnetic tape, the standard deviation (σPES) of the PES obtained by the above method was calculated for a region in the tape longitudinal direction over a length of 30 m to 200 m, where a terminal on the side wound around the reel of the magnetic tape cartridge is called an inner terminal, a terminal on the opposite side is called an outer terminal, and the outer terminal is set to 0 m. In a case where the σPES obtained in this way is 50 nm or less, it can be determined that the running stability is excellent.

### Evaluation of Magnetic Tape

### (1) Rate of Change in Protrusion Area Ratio and Dynamic Frictional Force F

The magnetic tape was taken out from each magnetic tape cartridge of Examples and Comparative Examples, and in an environment of a temperature of 35° C. and a relative humidity of 80%, the magnetic tape was subjected to the 1000 reciprocating slides by the method described above, and the protrusion area ratio after the reciprocating slide was obtained by the method described above. In a portion of the magnetic tape portion that was not subjected to the 1000 reciprocating slides, the protrusion area ratio was obtained by the method described above. From the protrusion area ratio before the reciprocating slide and the protrusion area ratio after the reciprocating slide, which were obtained in this way, the rate of change in protrusion area ratio was obtained by the above-described equation.

In addition, the dynamic frictional force F during the 1000th forward path in the 1000 reciprocating slides was obtained by the method described above.

As the LTO 8 head, a commercially available LTO 8 head (manufactured by IBM Corporation) was used.

### (2) Coefficient of Variation of Equivalent Circle Diameter of Bright Region

Using an FE-SEM S4800 manufactured by Hitachi, Ltd. as a scanning electron microscope (FE-SEM), the coefficient of variation of equivalent circle diameter of bright region of the magnetic layer surface of each magnetic tape was obtained by the following method.

A secondary electron image of the magnetic layer surface of the magnetic tape to be measured was captured using a scanning electron microscope (FE-SEM). The measurement point was set to one randomly selected point. The imaging is performed on the magnetic layer surface that is not subjected to the reciprocating slide described above. As imaging conditions, an acceleration voltage was 5 kV, an operating distance was 8 mm, and an imaging magnification was 10000×. In imaging, a non-imaging region on the magnetic layer surface was selected, focus adjustment was performed under the imaging conditions, and a secondary electron image was captured. A part (micron bar, cross mark, or the like) for displaying the size and the like was erased from the captured image, and a secondary electron image having the number of pixels of 960 pixels×1280 pixels was acquired.

The secondary electron image thus acquired was taken into image processing software, and was binarized by the following procedure. As image analysis software, free software ImageJ was used.

For a threshold value for binarizing the secondary electron image acquired above, a lower limit value was set to 100 gradations and an upper limit value was set to 130 gradations, and the binarization processing was executed based on these two threshold values. After the binarization processing, noise component removal processing was performed by the image analysis software. Specifically, in the image analysis software ImageJ, noise cut processing Despeckle was selected to remove the noise component.

For the binarized image thus obtained, the area of each of a plurality of bright regions (that is, white parts) included in the binarized image was obtained by the image analysis software. From the area of the bright region obtained here, the equivalent circle diameter of each bright region was obtained. Specifically, an equivalent circle diameter L was calculated from an obtained area A by 2×(A/π)\hat{ }(½)=L.

The coefficient of variation of equivalent circle diameter was calculated from the standard deviation σ and the arithmetic average of the equivalent circle diameters L obtained as described above, according to the above-described equation.

### (3) Tape Thickness

Ten tape samples (length of 5 cm) were cut out from any part of the magnetic tape taken out from each magnetic tape cartridge of Examples and Comparative Examples, and the thickness was measured by stacking these tape samples. The thickness was measured using a digital thickness gauge of Millimar 1240 compact amplifier and Millimar 1301 induction probe manufactured by MARH Inc. A value (thickness per tape sample) obtained by dividing the measured thickness by 1/10 was defined as the tape thickness. For each of the magnetic tapes of Example 1 to 14 and Comparative Examples 1 to 5, the tape thickness was 5.0 μm. The tape thickness of each magnetic tape of Examples 15 to 17 was as follows. Example 15: 4.6 μm, Example 16: 4.0 μm, Example 17:3.4μ m.

The above results are shown in Table 1 (Tables 1-1 to 1-5).

TABLE 1-1

| | | | Example 1 | | Example 2 | | Example 3 | | Example 4 | | Example 5 | |
|---|---|---|---|---|---|---|---|---|---|---|---|---|
| Magnetic | Ferromagnetic | Type | BaFe | | BaFe | | BaFe | | BaFe | | BaFe | |
| layer | powder | | | | | | | | | | | |
| | Protrusion | Type | B | | B | | B | | B | | B | |
| | forming agent | Adding | 1.0 | part | 2.0 | parts | 3.0 | parts | 2.0 | parts | 3.0 | parts |
| | | amount | | | | | | | | | | |
| | | Mohs | 7 | | 7 | | 7 | | 7 | | 7 | |
| | | hardness | | | | | | | | | | |
| | | Mixing type | Simultaneous | | Simultaneous | | Simultaneous | | Simultaneous | | Simultaneous | |
| | | | dispersion | | dispersion | | dispersion | | dispersion | | dispersion | |
| | Fatty acid | Type | b | | b | | b | | b | | b | |
| | ester | Adding | 1.0 | part | 1.0 | part | 1.0 | part | 1.0 | part | 1.0 | part |
| | | amount | | | | | | | | | | |

| Coefficient of variation of | 12.0% | 12.0% | 12.0% | 12.0% | 12.0% |
|---|---|---|---|---|---|
| equivalent circle diameter of | | | | | |
| bright region | | | | | |

| Non-magnetic layer | Dispersion | 360 | min | 360 | min | 360 | min | 420 | min | 420 | min |
|---|---|---|---|---|---|---|---|---|---|---|---|
| | time | | | | | | | | | | |
| Non-magnetic support | Type | PEN | | PEN | | PEN | | PEN | | PEN | |
| | Thickness | 4.0 | μm | 4.0 | μm | 4.0 | μm | 4.0 | μm | 4.0 | μm |
| Calender | Temperature | 100° | C. | 100° | C. | 100° | C. | 100° | C. | 100° | C. |

| | Number of | 2 | 2 | 2 | 2 | 2 |
|---|---|---|---|---|---|---|
| | times | | | | | |
| Rate of change in | | 10.0% | 9.0% | 7.0% | 8.0% | 6.5% |
| protrusion area ratio | | | | | | |
| Dynamic frictional force | Unit: gf | 15 | 14 | 12 | 13 | 10 |
| F | | | | | | |
| σPES | Unit: nm | 50 | 48 | 40 | 45 | 37 |

TABLE 1-2

| | | | Example 6 | | Example 7 | | Example 8 | | Example 9 | | Example 10 | |
|---|---|---|---|---|---|---|---|---|---|---|---|---|
| Magnetic | Ferromagnetic | Type | BaFe | | BaFe | | BaFe | | BaFe | | BaFe | |
| layer | powder | | | | | | | | | | | |
| | Protrusion | Type | B | | B | | C | | C | | B | |
| | forming agent | Adding | 2.0 | parts | 3.0 | parts | 1.0 | part | 2.0 | parts | 1.0 | part |
| | | amount | | | | | | | | | | |

| Mohs | 7 | 7 | 6 | 6 | 7 |
|---|---|---|---|---|---|
| hardness | | | | | |

| | | | | | | |
|---|---|---|---|---|---|---|
| | Mixing type | Simultaneous | Simultaneous | Simultaneous | Simultaneous | Simultaneous |
| | | dispersion | dispersion | dispersion | dispersion | dispersion |
| Fatty acid ester | Type | b | b | b | b | b |

| | | | | | | | | | | |
|---|---|---|---|---|---|---|---|---|---|---|
| Adding | 1.0 | part | 1.0 | part | 1.0 | part | 1.0 | part | 2.0 | parts |
| amount | | | | | | | | | | |

| Coefficient of variation of | 12.0% | 12.0% | 15.0% | 15.0% | 12.0% |
|---|---|---|---|---|---|
| equivalent circle diameter of | | | | | |
| bright region | | | | | |

| Non-magnetic layer | Dispersion | 420 | min | 420 | min | 360 | min | 360 | min | 360 | min |
|---|---|---|---|---|---|---|---|---|---|---|---|
| | time | | | | | | | | | | |
| Non-magnetic support | Type | PEN | | PEN | | PEN | | PEN | | PEN | |
| | Thickness | 4.0 | μm | 4.0 | μm | 4.0 | μm | 4.0 | μm | 4.0 | μm |
| Calender | Temperature | 100° | C. | 100° | C. | 100° | C. | 100° | C. | 100° | C. |

| | Number of | 3 | 3 | 2 | 2 | 2 |
|---|---|---|---|---|---|---|
| | \|times | | | | | |
| Rate of change in | | 5.0% | 2.5% | 10.0% | 9.0% | 10.0% |
| protrusion area ratio | | | | | | |
| Dynamic frictional force | Unit: gf | 8 | 5 | 15 | 15 | 14 |
| F | | | | | | |
| σPES | Unit: nm | 34 | 31 | 50 | 48 | 47 |

TABLE 1-3

| | | | Example 11 | | Example 12 | | Example 13 | | Example 14 | |
|---|---|---|---|---|---|---|---|---|---|---|
| Magnetic | Ferromagnetic | Type | BaFe | | SrFe1 | | SrFe2 | | ε-iron oxide | |
| layer | powder | | | | | | | | | |
| | Protrusion | Type | C | | B | | B | | B | |
| | forming agent | Adding | 1.0 | part | 3.0 | parts | 3.0 | parts | 3.0 | parts |
| | | amount | | | | | | | | |

| Mohs | 6 | 7 | 7 | 7 |
|---|---|---|---|---|
| hardness | | | | |

| | | | | | |
|---|---|---|---|---|---|
| | Mixing type | Simultaneous | Simultaneous | Simultaneous | Simultaneous |
| | | dispersion | dispersion | dispersion | dispersion |
| Fatty acid ester | Type | b | b | b | b |

| | | | | | | | | |
|---|---|---|---|---|---|---|---|---|
| Adding | 2.0 | parts | 1.0 | part | 1.0 | part | 1.0 | part |
| amount | | | | | | | | |

| Coefficient of variation of | 15.0% | 12.0% | 12.0% | 12.0% |
|---|---|---|---|---|
| equivalent circle diameter of | | | | |
| bright region | | | | |

| Non-magnetic layer | Dispersion | 360 | min | 420 | min | 420 | min | 420 | min |
|---|---|---|---|---|---|---|---|---|---|
| | time | | | | | | | | |
| Non-magnetic support | Type | PEN | | PEN | | PEN | | PEN | |
| | Thickness | 4.0 | μm | 4.0 | μm | 4.0 | μm | 4.0 | μm |
| Calender | Temperature | 100° | C. | 100° | C. | 100° | C. | 100° | C. |

| | Number of | 2 | 3 | 3 | 3 |
|---|---|---|---|---|---|
| | times | | | | |
| Rate of change in | | 10.0% | 2.5% | 2.5% | 2.5% |
| protrusion area ratio | | | | | |
| Dynamic frictional force F | Unit: gf | 13 | 5 | 5 | 5 |
| σPES | Unit: nm | 46 | 31 | 31 | 31 |

TABLE 1-4

| | | | Example 15 | | Example 16 | | Example 17 | |
|---|---|---|---|---|---|---|---|---|
| Magnetic | Ferromagnetic | Type | BaFe | | BaFe | | BaFe | |
| layer | powder | | | | | | | |
| | Protrusion | Type | B | | B | | B | |
| | forming agent | Adding | 1.0 | part | 1.0 | part | 1.0 | part |

| | amount | | | |
|---|---|---|---|---|
| | Mohs | 7 | 7 | 7 |
| | hardness | | | |
| | Mixing type | Simultaneous | Simultaneous | Simultaneous |
| | | dispersion | dispersion | dispersion |
| Fatty acid ester | Type | b | b | b |

| | | | | | | |
|---|---|---|---|---|---|---|
| Adding | 1.0 | part | 1.0 | part | 1.0 | part |

amount

| Coefficient of variation of | 12.0% | 12.0% | 12.0% |
|---|---|---|---|
| equivalent circle diameter of | | | |
| bright region | | | |

| Non-magnetic layer | Dispersion | 360 | min | 360 | min | 360 | min |
|---|---|---|---|---|---|---|---|
| | time | | | | | | |
| Non-magnetic support | Type | PA | | PA | | PA | |
| | Thickness | 3.6 | μm | 3.0 | μm | 2.4 | μm |
| Calender | Temperature | 100° | C. | 100° | C. | 100° | C. |

| | Number of | 2 | 2 | 2 |
|---|---|---|---|---|
| | times | | | |
| Rate of change in | | 10.0% | 10.0% | 10.0% |
| protrusion area ratio | | | | |
| Dynamic frictional force F | Unit: gf | 15 | 15 | 15 |
| σPES | Unit: nm | 50 | 50 | 50 |

TABLE 1-5

| | | | Comparative | | Comparative | | Comparative | | Comparative | | Comparative | |
|---|---|---|---|---|---|---|---|---|---|---|---|---|
| | | | Example 1 | | Example 2 | | Example 3 | | Example 4 | | Example 5 | |
| Magnetic | Ferromagnetic | Type | BaFe | | BaFe | | BaFe | | BaFe | | BaFe | |
| layer | powder | | | | | | | | | | | |
| | Protrusion | Type | A | | A | | A | | A | | B | |
| | forming agent | Adding | 1.0 | part | 2.0 | parts | 3.0 | parts | 1.0 | part | 1.0 | part |
| | | amount | | | | | | | | | | |

| Mohs | 3 | 3 | 3 | 3 | 7 |
|---|---|---|---|---|---|
| hardness | | | | | |

| | | | | | | |
|---|---|---|---|---|---|---|
| | Mixing type | Separate | Separate | Separate | Separate | Separate |
| | | dispersion | dispersion | dispersion | dispersion | dispersion |
| Fatty acid ester | Type | a | a | a | a | a |

| | | | | | | | | | | |
|---|---|---|---|---|---|---|---|---|---|---|
| Adding | 1.0 | part | 1.0 | part | 1.0 | part | 1.0 | part | 1.0 | part |
| amount | | | | | | | | | | |

| Coefficient of variation of | 30.0% | 30.0% | 30.0% | 30.0% | 12.0% |
|---|---|---|---|---|---|
| equivalent circle diameter | | | | | |
| of bright region | | | | | |

| Non-magnetic layer | Dispersion | 180 | min | 420 | min | 420 | min | 420 | min | 180 | min |
|---|---|---|---|---|---|---|---|---|---|---|---|
| | time | | | | | | | | | | |
| Non-magnetic support | Type | PEN | | PEN | | PEN | | PEN | | PEN | |
| | Thickness | 4.0 | μm | 4.0 | μm | 4.0 | μm | 4.0 | μm | 4.0 | μm |
| Calender | Temperature | 80° | C. | 80° | C. | 80° | C. | 100° | C. | 80° | C. |

| | Number of | 1 | 1 | 1 | 2 | 1 |
|---|---|---|---|---|---|---|
| | times | | | | | |
| Rate of change in | | 25.0% | 21.0% | 16.0% | 14.0% | 20.0% |
| protrusion area ratio | | | | | | |
| Dynamic frictional force | Unit: gf | 35 | 32 | 26 | 21 | 31 |
| F | | | | | | |
| σPES | Unit: nm | 77 | 70 | 64 | 60 | 67 |

From the results shown in Table 1, it can be confirmed that the magnetic tapes of Examples in which the rate of change in protrusion area ratio was 10.0% or less exhibited excellent running stability in a case where the magnetic tape was run with the head tilted in a high temperature and high humidity environment.

A magnetic tape was manufactured by the method described in Example 1, except that the vertical alignment treatment was not performed in a case of manufacturing the magnetic tape.

A sample piece was cut out from the magnetic tape. For this sample piece, a vertical squareness ratio obtained by the method described above using a TM-TRVSM5050-SMSL type manufactured by Tamakawa Co., Ltd. as a vibrating sample magnetometer was 0.55.

The vertical squareness ratio similarly obtained for the sample piece cut out from the magnetic tape of Example 1 was 0.65.

Each of the above two magnetic tapes was mounted to a reel tester of ½ inches, and electromagnetic conversion characteristics (signal-to-noise ratio (SNR)) were evaluated by the following method. As a result, for the magnetic tape of Example 1, a value of SNR higher by 4 dB was obtained as compared with the magnetic tape manufactured without the vertical alignment treatment.

In an environment of a temperature of 23° C. and a relative humidity of 50%, a tension of 0.7 N (Newton) was applied in the longitudinal direction of the magnetic tape, and recording and reproduction were performed for 10 passes. A relative speed between the magnetic tape and the magnetic head was set to 6 m/sec, and recording was performed by using a metal-in-gap (MIG) head (a gap length of 0.15 μm and a track width of 1.0 μm) as a recording head and setting a recording current to an optimal recording current of each magnetic tape. Reproduction was performed by using a giant-magnetoresistive (GMR) head (an element thickness of 15 nm, a shield interval of 0.1 μm, and a reproducing element width of 0.8 μm) as a reproducing head. The head tilt angle was set to 0°. A signal having a linear recording density of 300 kfci was recorded, and measurement regarding a reproduction signal was performed with a spectrum analyzer manufactured by Shibasoku Co., Ltd. The unit kfci is a unit of a linear recording density (cannot be converted into an SI unit system). As the signal, a portion where the signal was sufficiently stable after start of the running of the magnetic tape was used.

One aspect of the present invention is useful in various data storage technical fields.

What is claimed is:

1. A magnetic tape comprising:
a non-magnetic support; and
a magnetic layer containing a ferromagnetic powder,
wherein a rate of change in an area ratio of a protrusion having a height of 5 nm or more and 10 nm or less, which is obtained by measuring a measurement region of 5 μm×5 μm on a surface of the magnetic layer before and after 1000 reciprocating slides with respect to an LTO 8 head at a head tilt angle of 15° in an environment of a temperature of 35° C. and a relative humidity of 80%, with an atomic force microscope, is 10.0% or less.

2. The magnetic tape according to claim 1,
wherein a dynamic frictional force F during a 1000th forward path in the reciprocating slide is 15 gf or less.

3. The magnetic tape according to claim 1,
wherein a coefficient of variation of an equivalent circle diameter of a bright region in an image of a secondary electron image obtained by imaging the surface of the magnetic layer before the reciprocating slide with a scanning electron microscope at an acceleration voltage of 5 kV is 15.0% or less, the image being subjected to binarization processing, and
a lower limit value of a threshold value in the binarization processing is 100 gradations and an upper limit value of the threshold value is 130 gradations.

4. The magnetic tape according to claim 3,
wherein the magnetic layer further contains a non-magnetic powder having a Mohs hardness of 6 or more and 7 or less.

5. The magnetic tape according to claim 1, further comprising:
a non-magnetic layer containing a non-magnetic powder between the non-magnetic support and the magnetic layer.

6. The magnetic tape according to claim 1, further comprising:
a back coating layer containing a non-magnetic powder on a surface side of the non-magnetic support opposite to a surface side having the magnetic layer.

7. The magnetic tape according to claim 1,
wherein a tape thickness of the magnetic tape is 5.0 μm or less.

8. The magnetic tape according to claim 1,
wherein a vertical squareness ratio of the magnetic tape is 0.60 or more.

9. The magnetic tape according to claim 1,
wherein a vertical squareness ratio of the magnetic tape is 0.65 or more.

10. The magnetic tape according to claim 1,
wherein the non-magnetic support is an aromatic polyamide support.

11. The magnetic tape according to claim 1,
wherein a dynamic frictional force F during a 1000th forward path in the reciprocating slide is 15 gf or less,
a coefficient of variation of an equivalent circle diameter of a bright region in an image of a secondary electron image obtained by imaging the surface of the magnetic layer before the reciprocating slide with a scanning electron microscope at an acceleration voltage of 5 kV is 15.0% or less, the image being subjected to binarization processing,
a lower limit value of a threshold value in the binarization processing is 100 gradations and an upper limit value of the threshold value is 130 gradations,
the magnetic layer further contains a non-magnetic powder having a Mohs hardness of 6 or more and 7 or less,
the magnetic tape further includes a non-magnetic layer containing a non-magnetic powder between the non-magnetic support and the magnetic layer,
the magnetic tape further includes a back coating layer containing a non-magnetic powder on a surface side of the non-magnetic support opposite to a surface side having the magnetic layer,
a tape thickness is 5.0 μm or less, and
a vertical squareness ratio of the magnetic tape is 0.60 or more.

12. A magnetic tape cartridge comprising:
the magnetic tape according to claim 1.

13. A magnetic tape apparatus comprising:
the magnetic tape according to claim 1.

14. The magnetic tape apparatus according to claim 13, further comprising:
a magnetic head,
wherein the magnetic head has a module including an element array with a plurality of magnetic head elements between a pair of servo signal reading elements, and
the magnetic tape apparatus changes an angle θ formed by an axis of the element array with respect to a width direction of the magnetic tape during running of the magnetic tape in the magnetic tape apparatus.
